(19) United States
(12) Patent Application Publication
(10) Pub. No.: US 2025/0323774 A1
(43) Pub. Date: Oct. 16, 2025

(54) TRANSMISSION OF RESOURCE UNITS BY NARROW BANDWIDTH OPERATING DEVICES IN WIDE BANDWIDTH SPECTRUM

(71) Applicant: QUALCOMM Incorporated, San Diego, CA (US)

(72) Inventors: Lin YANG, San Diego, CA (US); Qifan CHEN, Newark, CA (US); Bin TIAN, San Diego, CA (US); Youhan KIM, Saratoga, CA (US)

(21) Appl. No.: 18/633,357

(22) Filed: Apr. 11, 2024

(51) Int. Cl. H04L 5/00

(52) U.S. Cl. CPC H04L 5/0092

(57) ABSTRACT

This disclosure provides methods, components, devices and systems for transmission of resource units by narrow bandwidth operating devices in wide bandwidth spectrum. A station (STA) may identify or receive a resource unit (RU) allocation including a global RU index for a wide bandwidth. The STA may translate the global RU index into a local RU index for a local tone plan, may map the assigned RU to distributed RU (dRU) tones over a corresponding distribution bandwidth, and may shift the mapped dRU tones to align with the wide bandwidth. The STA also may support transmission of short training fields (STFs) and long training fields (LTFs) using a similar mapping and shifting, or using tones of the wide bandwidth that fall within the distribution bandwidth region. A STA also may support a tone plan splitting a wide bandwidth into segments of the distribution bandwidth to allow direct mapping.

### TECHNICAL FIELD

This disclosure relates generally to wireless communication and, more specifically, to transmission of resource units by narrow bandwidth operating devices in wide bandwidth spectrum.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

In some WLANs, one or more wireless devices, such as wireless APs or wireless STAs, may communicate using one or more tone plans for mapping tones of messages, including physical layer (PHY) protocol data unit (PPDUs). In some examples, a STA may be allocated a quantity of tones for transmission of a PPDU, which may represent a logical resource unit (RU). STAs may support “regular RUs” (or rRUs), RU tone plans that are not distributed, as well as “distributed RUs” (or dRUs), RU tone plans in which tones are distributed across a set of noncontiguous subcarrier indices to which a logical RU is mapped.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a station (STA). The method may include identifying a resource unit (RU) allocation for the STA including a first RU index, the first RU index associated with a first channel of a first bandwidth, mapping a quantity of N tones to a first set of N non-contiguous subcarrier indices of a set of multiple subcarrier indices spanning a second channel of a second bandwidth less than the first bandwidth, where the first set of N subcarrier indices are selected from a set of multiple sets of N subcarrier indices of the second bandwidth based on a second RU index that corresponds to a position of the first RU index mapped to the second bandwidth, shifting the mapped N tones to a second set of N subcarrier indices of the first channel according to a shifting value associated with the first RU index, and the second bandwidth, and transmitting a message over the first channel based on the mapping of the N tones and the shifting.

Another innovative aspect of the subject matter described in this disclosure can be implemented in a STA for wireless communications. The STA may include a processing system that includes processor circuitry and memory circuitry that stores code. The processing system may be configured to cause the STA to identify an RU allocation for the STA including a first RU index, the first RU index associated with a first channel of a first bandwidth, map a quantity of N tones to a first set of N non-contiguous subcarrier indices of a set of multiple subcarrier indices spanning a second channel of a second bandwidth less than the first bandwidth, where the first set of N subcarrier indices are selected from a set of multiple sets of N subcarrier indices of the second bandwidth based on a second RU index that corresponds to a position of the first RU index mapped to the second bandwidth, shift the mapped N tones to a second set of N subcarrier indices of the first channel according to a shifting value associated with the first RU index, and the second bandwidth, and transmit a message over the first channel based on the mapping of the N tones and the shifting.

Another innovative aspect of the subject matter described in this disclosure can be implemented in a STA for wireless communications. The STA may include means for identifying an RU allocation for the STA including a first RU index, the first RU index associated with a first channel of a first bandwidth, means for mapping a quantity of N tones to a first set of N non-contiguous subcarrier indices of a set of multiple subcarrier indices spanning a second channel of a second bandwidth less than the first bandwidth, where the first set of N subcarrier indices are selected from a set of multiple sets of N subcarrier indices of the second bandwidth based on a second RU index that corresponds to a position of the first RU index mapped to the second bandwidth, means for shifting the mapped N tones to a second set of N subcarrier indices of the first channel according to a shifting value associated with the first RU index, and the second bandwidth, and means for transmitting a message over the first channel based on the mapping of the N tones and the shifting.

Another innovative aspect of the subject matter described in this disclosure can be implemented in a non-transitory computer-readable medium storing code for wireless communications is described. The code may include instructions executable by one or more processors to identify an RU allocation for the STA including a first RU index, the first RU index associated with a first channel of a first bandwidth, map a quantity of N tones to a first set of N non-contiguous subcarrier indices of a set of multiple subcarrier indices spanning a second channel of a second bandwidth less than the first bandwidth, where the first set of N subcarrier indices are selected from a set of multiple sets of N subcarrier indices of the second bandwidth based on a second RU index that corresponds to a position of the first RU index mapped to the second bandwidth, shift the mapped N tones to a second set of N subcarrier indices of the first channel according to a shifting value associated with the first RU index, and the second bandwidth, and transmit a message over the first channel based on the mapping of the N tones and the shifting.

Some examples of the method, STAs, and non-transitory computer-readable medium described herein may further include operations, features, means, or instructions for transmitting a short training field (STF) over the first channel using one or more STF tones based on the mapping.

In some examples of the method, STAs, and non-transitory computer-readable medium described herein, a sequence and tone plan of the STF may be based on the second channel of the second bandwidth and transmitting the STF may be based on shifting the STF tones to subcarrier indices of the first channel according to a shifting value associated with the first RU index and the second bandwidth. In some examples of the method, STAs, and non-transitory computer-readable medium described herein, a sequence of the STF may be based on the first bandwidth and transmitting the STF may be based on mapping a set of multiple STF tones to one or more subcarrier indices distributed across the first channel and using the one or more STF tones that may be within the second channel and that may be of the set of multiple STF tones.

Some examples of the method, STAs, and non-transitory computer-readable medium described herein may further include operations, features, means, or instructions for transmitting the STF may be in accordance with a cyclic shift delay (CSD) with a global CSD index associated with the second RU index. Some examples of the method, STAs, and non-transitory computer-readable medium described herein may further include operations, features, means, or instructions for transmitting a long training field (LTF) over the first channel using one or more LTF tones based on the mapping, where a sequence of the LTF may be based on the second bandwidth, and where transmitting the LTF may be based on mapping the one or more LTF tones to one or more subcarrier indices of the set of multiple subcarrier indices spanning the second channel, and shifting the mapped LTF tones.

In some examples of the method, STAs, and non-transitory computer-readable medium described herein, the first bandwidth includes an 80 MHz bandwidth and the second bandwidth includes a 20 MHz bandwidth or a 40 MHz bandwidth. In some examples of the method, STAs, and non-transitory computer-readable medium described herein, the RU allocation may be based on a capability of the STA.

One innovative aspect of the subject matter described in this disclosure can be implemented in a method for wireless communications by a STA. The method may include identifying an RU allocation for the STA and a first RU index, the first RU index associated with a first channel of a first bandwidth, and the RU allocation indicating a second channel of a second bandwidth, mapping a quantity of N tones to a first set of N subcarrier indices of a set of multiple subcarrier indices spanning a frequency subblock of the first channel in accordance with a tone plan associated with the subblock, the subblock of a second bandwidth less than the first bandwidth and including a quantity of M tones that is greater than the quantity of N tones, and the first channel including more than one subblock, each subblock of the more than one subblock including a direct current (DC) subcarrier and one or more guard tones at edges of the subblock, and transmitting a message over the first channel based on the mapping of the N tones in accordance with the tone plan.

Another innovative aspect of the subject matter described in this disclosure can be implemented in a STA for wireless communications. The STA may include a processing system that includes processor circuitry and memory circuitry that stores code. The processing system may be configured to cause the STA to identify an RU allocation for the STA and a first RU index, the first RU index associated with a first channel of a first bandwidth, and the RU allocation indicating a second channel of a second bandwidth, map a quantity of N tones to a first set of N subcarrier indices of a set of multiple subcarrier indices spanning a frequency subblock of the first channel in accordance with a tone plan associated with the subblock, the subblock of a second bandwidth less than the first bandwidth and including a quantity of M tones that is greater than the quantity of N tones, and the first channel including more than one subblock, each subblock of the more than one subblock including a DC subcarrier and one or more guard tones at edges of the subblock, and transmit a message over the first channel based on the mapping of the N tones in accordance with the tone plan.

Another innovative aspect of the subject matter described in this disclosure can be implemented in a STA for wireless communications. The STA may include means for identifying an RU allocation for the STA and a first RU index, the first RU index associated with a first channel of a first bandwidth, and the RU allocation indicating a second channel of a second bandwidth, means for mapping a quantity of N tones to a first set of N subcarrier indices of a set of multiple subcarrier indices spanning a frequency subblock of the first channel in accordance with a tone plan associated with the subblock, the subblock of a second bandwidth less than the first bandwidth and including a quantity of M tones that is greater than the quantity of N tones, and the first channel including more than one subblock, each subblock of the more than one subblock including a DC subcarrier and one or more guard tones at edges of the subblock, and means for transmitting a message over the first channel based on the mapping of the N tones in accordance with the tone plan.

Another innovative aspect of the subject matter described in this disclosure can be implemented in a non-transitory computer-readable medium storing code for wireless communications. The code may include instructions executable by one or more processors to identify an RU allocation for the STA and a first RU index, the first RU index associated with a first channel of a first bandwidth, and the RU allocation indicating a second channel of a second bandwidth, map a quantity of N tones to a first set of N subcarrier indices of a set of multiple subcarrier indices spanning a frequency subblock of the first channel in accordance with a tone plan associated with the subblock, the subblock of a second bandwidth less than the first bandwidth and including a quantity of M tones that is greater than the quantity of N tones, and the first channel including more than one subblock, each subblock of the more than one subblock including a DC subcarrier and one or more guard tones at edges of the subblock, and transmit a message over the first channel based on the mapping of the N tones in accordance with the tone plan.

In some examples of the method, STAs, and non-transitory computer-readable medium described herein, the tone plan associated with the subblock may be different than a second tone plan associated with a second subblock of the first channel, the second subblock of a third bandwidth different from the first bandwidth and the second bandwidth. In some examples of the method, STAs, and non-transitory computer-readable medium described herein, the first bandwidth includes an 80 MHZ bandwidth, the second bandwidth includes a 20 MHz bandwidth, and the third bandwidth includes a 40 MHz bandwidth. In some examples of the method, STAs, and non-transitory computer-readable medium described herein, the first channel includes four subblocks including the subblock and each of the four subblocks may be associated with the tone plan. In some examples of the method, STAs, and non-transitory computer-readable medium described herein, the first bandwidth includes an 80 MHZ bandwidth and the second bandwidth includes a 20 MHz bandwidth.

In some examples of the method, STAs, and non-transitory computer-readable medium described herein, the first channel includes two subblocks including the subblock and each of the two subblocks may be associated with the tone plan. In some examples of the method, STAs, and non-transitory computer-readable medium described herein, the first bandwidth includes a 40 MHz bandwidth and the second bandwidth includes a 20 MHz bandwidth. In some examples of the method, STAs, and non-transitory computer-readable medium described herein, the RU allocation may be based on a capability of the STA.

One innovative aspect of the subject matter described in this disclosure can be implemented in a method for wireless communications by an access point (AP). The method may include transmitting a control message indicating an RU allocation for a STA including a first RU index, the first RU index associated with a first channel of a first bandwidth and receiving a message over the first channel based on a quantity of N tones that are mapped to a first set of N non-contiguous subcarrier indices of a set of multiple subcarrier indices spanning a second channel of a second bandwidth less than the first bandwidth and that are shifted to a second set of N subcarrier indices of the first channel according to a shifting value associated with the first RU index, and the second bandwidth, where the first set of N subcarrier indices are from a set of multiple sets of N subcarrier indices of the second bandwidth and are associated with a second RU index that corresponds to a position of the first RU index mapped to the second bandwidth.

Another innovative aspect of the subject matter described in this disclosure can be implemented in an AP for wireless communications. The AP may include a processing system that includes processor circuitry and memory circuitry that stores code. The processing system may be configured to cause the AP to transmit a control message indicating an RU allocation for a STA including a first RU index, the first RU index associated with a first channel of a first bandwidth and receive a message over the first channel based on a quantity of N tones that are mapped to a first set of N non-contiguous subcarrier indices of a set of multiple subcarrier indices spanning a second channel of a second bandwidth less than the first bandwidth and that are shifted to a second set of N subcarrier indices of the first channel according to a shifting value associated with the first RU index, and the second bandwidth, where the first set of N subcarrier indices are from a set of multiple sets of N subcarrier indices of the second bandwidth and are associated with a second RU index that corresponds to a position of the first RU index mapped to the second bandwidth.

Another innovative aspect of the subject matter described in this disclosure can be implemented in an AP for wireless communications. The AP may include means for transmitting a control message indicating an RU allocation for a STA including a first RU index, the first RU index associated with a first channel of a first bandwidth and means for receiving a message over the first channel based on a quantity of N tones that are mapped to a first set of N non-contiguous subcarrier indices of a set of multiple subcarrier indices spanning a second channel of a second bandwidth less than the first bandwidth and that are shifted to a second set of N subcarrier indices of the first channel according to a shifting value associated with the first RU index, and the second bandwidth, where the first set of N subcarrier indices are from a set of multiple sets of N subcarrier indices of the second bandwidth and are associated with a second RU index that corresponds to a position of the first RU index mapped to the second bandwidth.

Another innovative aspect of the subject matter described in this disclosure can be implemented in a non-transitory computer-readable medium storing code for wireless communications. The code may include instructions executable by one or more processors to transmit a control message indicating an RU allocation for a STA including a first RU index, the first RU index associated with a first channel of a first bandwidth and receive a message over the first channel based on a quantity of N tones that are mapped to a first set of N non-contiguous subcarrier indices of a set of multiple subcarrier indices spanning a second channel of a second bandwidth less than the first bandwidth and that are shifted to a second set of N subcarrier indices of the first channel according to a shifting value associated with the first RU index, and the second bandwidth, where the first set of N subcarrier indices are from a set of multiple sets of N subcarrier indices of the second bandwidth and are associated with a second RU index that corresponds to a position of the first RU index mapped to the second bandwidth.

Some examples of the method, APs, and non-transitory computer-readable medium described herein may further include operations, features, means, or instructions for receiving an STF over the first channel using one or more STF tones based on the mapping.

In some examples of the method, APs, and non-transitory computer-readable medium described herein, a sequence and tone plan of the STF may be associated with the second channel of the second bandwidth and receiving the STF includes receiving the STF tones that may be shifted to subcarrier indices of the first channel according to a shifting value associated with the first RU index and the second bandwidth. In some examples of the method, APs, and non-transitory computer-readable medium described herein, a sequence of the STF may be associated with the first bandwidth and receiving the STF may be based on a set of multiple STF tones that may be mapped to one or more subcarrier indices distributed across the first channel and using the one or more STF tones that may be within the second channel and that may be of the set of multiple STF tones.

Some examples of the method, APs, and non-transitory computer-readable medium described herein may further include operations, features, means, or instructions for receiving the STF may be in accordance with CSD with a global CSD index associated with the second RU index. Some examples of the method, APs, and non-transitory computer-readable medium described herein may further include operations, features, means, or instructions for receiving an LTF over the first channel using one or more LTF tones based on the mapping of the N tones, where a sequence of the LTF may be associated with the second bandwidth, and where receiving the LTF may be based on one or more LTF tones that may be mapped to one or more subcarrier indices of the set of multiple subcarrier indices spanning the second channel and that may be shifted.

In some examples of the method, APs, and non-transitory computer-readable medium described herein, the first bandwidth includes an 80 MHz bandwidth and the second bandwidth includes a 20 MHz bandwidth or a 40 MHz bandwidth. In some examples of the method, APs, and non-transitory computer-readable medium described herein, the RU allocation may be based on a capability of the STA.

One innovative aspect of the subject matter described in this disclosure can be implemented in a method for wireless communications by an AP. The method may include transmitting a control message indicating an RU allocation for a STA and a first RU index, the first RU index associated with a first channel of a first bandwidth, and the RU allocation indicating a second channel of a second bandwidth and receiving a message over the first channel based on a quantity of N tones that are mapped to a first set of N subcarrier indices of a set of multiple subcarrier indices spanning a frequency subblock of the first channel in accordance with a tone plan associated with the subblock, the subblock of a second bandwidth less than the first bandwidth and including a quantity of M tones that is greater than the quantity of N tones, and the first channel including more than one subblock, each subblock of the more than one subblock including a DC subcarrier and one or more guard tones at edges of the subblock.

Another innovative aspect of the subject matter described in this disclosure can be implemented in an AP for wireless communications. The AP may include a processing system that includes processor circuitry and memory circuitry that stores code. The processing system may be configured to cause the AP to transmit a control message indicating an RU allocation for a STA and a first RU index, the first RU index associated with a first channel of a first bandwidth, and the RU allocation indicating a second channel of a second bandwidth and receive a message over the first channel based on a quantity of N tones that are mapped to a first set of N subcarrier indices of a set of multiple subcarrier indices spanning a frequency subblock of the first channel in accordance with a tone plan associated with the subblock, the subblock of a second bandwidth less than the first bandwidth and including a quantity of M tones that is greater than the quantity of N tones, and the first channel including more than one subblock, each subblock of the more than one subblock including a DC subcarrier and one or more guard tones at edges of the subblock.

Another innovative aspect of the subject matter described in this disclosure can be implemented in an AP for wireless communications. The AP may include means for transmitting a control message indicating an RU allocation for a STA and a first RU index, the first RU index associated with a first channel of a first bandwidth, and the RU allocation indicating a second channel of a second bandwidth and means for receiving a message over the first channel based on a quantity of N tones that are mapped to a first set of N subcarrier indices of a set of multiple subcarrier indices spanning a frequency subblock of the first channel in accordance with a tone plan associated with the subblock, the subblock of a second bandwidth less than the first bandwidth and including a quantity of M tones that is greater than the quantity of N tones, and the first channel including more than one subblock, each subblock of the more than one subblock including a DC subcarrier and one or more guard tones at edges of the subblock.

Another innovative aspect of the subject matter described in this disclosure can be implemented in a non-transitory computer-readable medium storing code for wireless communications. The code may include instructions executable by one or more processors to transmit a control message indicating an RU allocation for a STA and a first RU index, the first RU index associated with a first channel of a first bandwidth, and the RU allocation indicating a second channel of a second bandwidth and receive a message over the first channel based on a quantity of N tones that are mapped to a first set of N subcarrier indices of a set of multiple subcarrier indices spanning a frequency subblock of the first channel in accordance with a tone plan associated with the subblock, the subblock of a second bandwidth less than the first bandwidth and including a quantity of M tones that is greater than the quantity of N tones, and the first channel including more than one subblock, each subblock of the more than one subblock including a DC subcarrier and one or more guard tones at edges of the subblock.

In some examples of the method, APs, and non-transitory computer-readable medium described herein, the tone plan associated with the subblock may be different than a second tone plan associated with a second subblock of the first channel, the second subblock of a third bandwidth different from the first bandwidth and the second bandwidth. In some examples of the method, APs, and non-transitory computer-readable medium described herein, the first bandwidth includes an 80 MHz bandwidth, the second bandwidth includes a 20 MHz bandwidth, and the third bandwidth includes a 40 MHz bandwidth. In some examples of the method, APs, and non-transitory computer-readable medium described herein, the first channel includes four subblocks including the subblock and each of the four subblocks may be associated with the tone plan. In some examples of the method, APs, and non-transitory computer-readable medium described herein, the first bandwidth includes an 80 MHz bandwidth and the second bandwidth includes a 20 MHz bandwidth.

In some examples of the method, APs, and non-transitory computer-readable medium described herein, the first channel includes two subblocks including the subblock and each of the two subblocks may be associated with the tone plan. In some examples of the method, APs, and non-transitory computer-readable medium described herein, the first bandwidth includes a 40 MHz bandwidth and the second bandwidth includes a 20 MHz bandwidth. In some examples of the method, APs, and non-transitory computer-readable medium described herein, the RU allocation may be based on a capability of the STA.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a frequency diagram depicting an example distributed tone mapping.

FIG. 6 shows an example of a tone plan diagram that supports transmission of resource units by narrow bandwidth operating devices in wide bandwidth spectrum.

FIGS. 7A and 7B show examples of a signaling diagram and a tone plan diagram that supports transmission of resource units by narrow bandwidth operating devices in wide bandwidth spectrum.

FIGS. 8A and 8B show examples of frequency diagrams that supports transmission of resource units by narrow bandwidth operating devices in wide bandwidth spectrum.

FIGS. 9A and 9B show examples of tone plan diagrams that support transmission of resource units by narrow bandwidth operating devices in wide bandwidth spectrum.

FIG. 10 shows an example of a process flow that supports transmission of resource units by narrow bandwidth operating devices in wide bandwidth spectrum.

FIG. 11 shows an example of a process flow that supports transmission of resource units by narrow bandwidth operating devices in wide bandwidth spectrum.

FIG. 12 shows a block diagram of an example wireless communication device that supports transmission of resource units by narrow bandwidth operating devices in wide bandwidth spectrum.

FIG. 13 shows a block diagram of an example wireless communication device that supports transmission of resource units by narrow bandwidth operating devices in wide bandwidth spectrum.

FIGS. 14 and 15 show flowcharts illustrating example processes performable by or at a STA that supports transmission of resource units by narrow bandwidth operating devices in wide bandwidth spectrum.

FIGS. 16 and 17 show flowcharts illustrating example processes performable by or at an AP that supports transmission of resource units by narrow bandwidth operating devices in wide bandwidth spectrum.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Various aspects relate generally to transmission of resource units (RUs) by narrow bandwidth operating devices within wide bandwidth PPDUs. In some examples, a Wi-Fi system may support different tone plans for transmissions. Tone plans may, for example, map a quantity of tones of an RU to corresponding subcarrier indices for transmission. In regular RU (rRU) tone plans, tones may span all subcarriers of a bandwidth, with the exception of one or more guard tones (such as edge tones) and middle tones (such as direct current (DC) tones) that may not be used to protect transmissions, among other unused subcarriers. Distributed RU (dRU) tone plans however may map a quantity of logical tones corresponding to an RU to one or more noncontiguous tones distributed across a wider bandwidth with a larger quantity of tones. Some devices, such as stations (STAs), may operate on a narrower bandwidth however than bandwidths used in one or more RUs configured by an access point (AP), which may cause one or more data tones in the tone plan defined for the wide PPDU bandwidth to overlap with DC tones of the narrow bandwidth operating devices, which may reduce a quality of transmissions. Further, one or more procedures may not be defined for allowing narrow bandwidth operating STAs to operate within a wider PPDU bandwidth.

As described herein, a dRU mapped to a narrow distribution bandwidth may be shifted into a wide bandwidth, such as a physical layer (PHY) protocol data unit (PPDU) bandwidth, to enable transmission. For example, a narrow bandwidth operation device, such as a STA, may identify or receive an RU allocation including a global RU index for a wide PPDU bandwidth (such as 80 MHZ). The STA may translate the global RU index into a local RU index for a local tone plan, and may map the assigned RU to dRU tones over a corresponding distribution bandwidth. The STA may shift the mapped dRU tones so that the tones may align with the wide PPDU bandwidth. The STA also may support transmission of short training fields (STFs) and long training fields (LTFs) using a similar mapping and shifting, or may transmit STFs using tones according to the PPDU bandwidth that fall within the distribution bandwidth region in which transmission takes place. A STA may in some implementations use a new tone plan instead of shifting, which may reduce damage to transmissions from narrow bandwidth DC leakage. For example, a STA may support a tone plan that may split a PPDU bandwidth into additional segments of the distribution bandwidth, allowing the STA to directly map tones of the dRU to the distribution bandwidth region of the PPDU bandwidth for transmission. A STA also may define one or more dRU transmission rules to improve communication using a spectrum.

Particular aspects of the subject matter described in this disclosure can be implemented to realize one or more of the following potential advantages. In some examples, shifting mapped dRU tones to align with a PPDU bandwidth may provide backwards compatibility and wider device support by enabling devices supporting narrower bandwidths (such as 20 MHz devices) to communicate within a wider PPDU. Further, by implementing a tone plan that splits a PPDU bandwidth into smaller segments of the distribution bandwidth, dRU tones may be directly mapped to reduce direct current (DC) or local oscillator (LO) leakage. New segments (such as subblocks of frequencies, subbands) of such a tone plan may further reduce a quantity of guard tones in a distribution bandwidth mask, enabling additional device compatibility and higher performance, while improving performance in transmissions for rRU transmission related bandwidths as well. Further, transmitting STFs based on a wider bandwidth when shifting a narrow bandwidth dRU into a wider bandwidth may reduce a complexity at a receiving device by maintaining a periodicity of the STF, while a segmented tone plan may enable maintaining STF periodicity regardless.

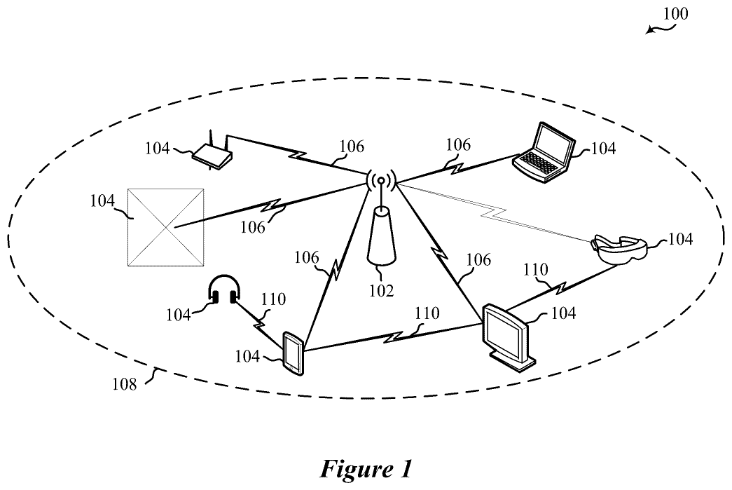

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless AP 102 and any number of wireless STAs 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FRI (410 MHZ-7.125 GHZ), FR2 (24.25 GHZ-52.6 GHz), FR3 (7.125 GHZ-24.25 GHZ), FR4a or FR4-1 (52.6 GHz-71 GHZ), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHZ, 80 MHz, or 160 MHZ portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHZ, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHZ channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (for example, High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHZ bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHZ.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

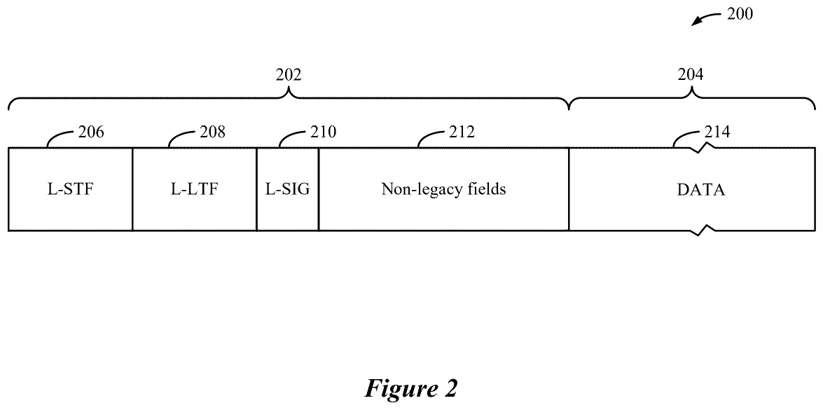

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

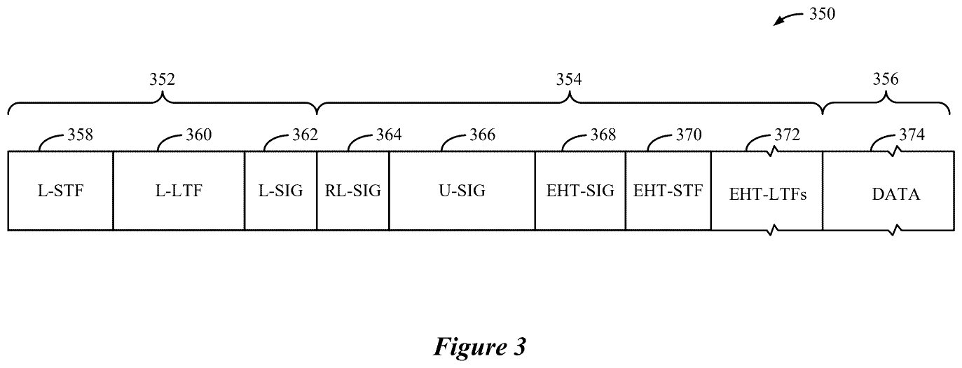

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT—or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as an AP 102 or a STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include RU allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

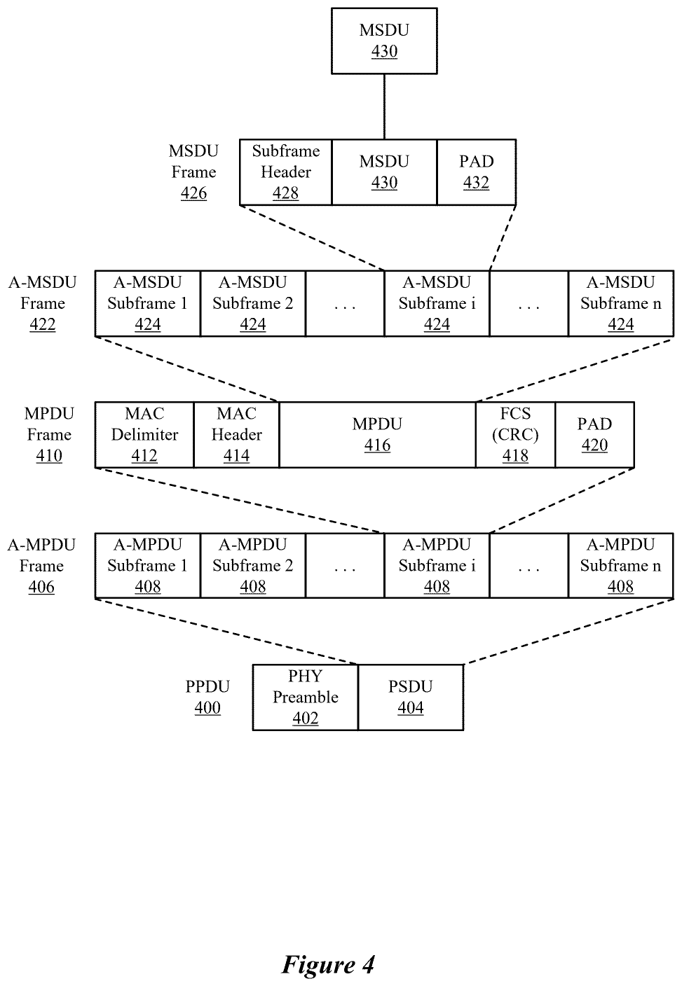

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

APs and STAs (for example, the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (e.g., there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; for example concurrent transmissions from one device to each of multiple devices (e.g., multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple RUs each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHZ and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHZ). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

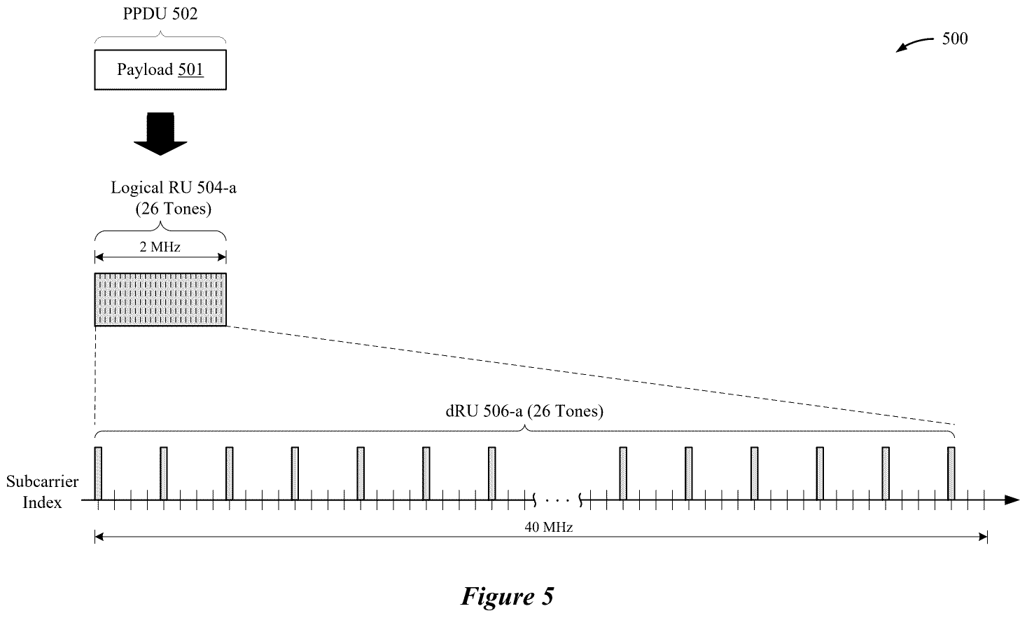

FIG. 5 shows a frequency diagram 500 depicting an example distributed tone mapping. More specifically, FIG. 5 shows an example mapping of how the tones of a payload 501 of a PPDU 502 are distributed for transmission over a spreading bandwidth of a wireless channel. In the illustrated example, the tones in a logical RU 504, such as a logical RU 504-a (which may represent an rRU of non-distributed tones in accordance with a legacy tone plan) associated with payload 501 are mapped to a dRU 506, such as a dRU 506-a, in accordance with a distributed tone plan.

Aspects of the present disclosure recognize that by distributing the tones across a wider bandwidth, the per-tone transmit power of a logical RU 504-a may be increased to provide greater flexibility in medium utilization for PSD-limited wireless channels. For example, when mapped to an rRU such as logical RU 504-a, the transmit power of the logical RU 504-a may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 504-a is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 502, without exceeding the PSD limits of the wireless channel. As shown in the example of FIG. 5, the STA 104 may map logical RU 504-a to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 5 effectively reduces the number of tones (of the logical RU 504-a) in each 1 MHz subchannel. For example, each of the 26 tones can be mapped to a different 1 MHz subchannel of the 40 MHz channel. As a result, each AP 102 or STA 104 implementing the distributed tone mapping of FIG. 5 can maximize its per-tone transmit power (which may maximize the overall transmit power of the logical RU 504-a).

In some examples (not shown in FIG. 5), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 502 is transmitted on tones spanning an rRU, such as a logical RU 504 (according to a legacy tone plan), or a dRU 506 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some examples, the trigger frame may be further configured to carry tone distribution information indicating whether the logical RU (or MRU) maps to an rRU or a dRU.

In some implementations, a STA 104 may include a distributed tone mapper that maps the logical RU 504-a to the dRU 506-a in the frequency domain. The dRU 506-a is converted to a time-domain signal (such as by an inverse fast Fourier transform (IFFT)) for transmission over a wireless channel. The AP 102 may receive the time-domain signal and reconstruct the dRU 506-a (such as by a fast Fourier transform (FFT)). In some implementations, the AP 102 may include a distributed tone demapper that demaps the dRU 506-a to the logical RU 504-a. In other words, the distributed tone demapper reverses the mapping performed by the distributed tone mapper at the STA 104. The AP 102 can recover the information carried (or modulated) on the logical RU 504-a as a result of the demapping.

In the example of FIG. 5, the logical RU 504-a is distributed evenly across the spreading bandwidth. While the example shown in FIG. 5 illustrates a spreading bandwidth of 40 MHz, spreading bandwidths also may include 80 MHz, 160 MHz, or 320 MHz. In some implementations, the logical RU 504-a can be mapped to any suitable pattern of noncontiguous subcarrier indices. For example, in various implementations, the distance between any pair of adjacent modulated tones may be less than or greater than the distances depicted in FIG. 5.

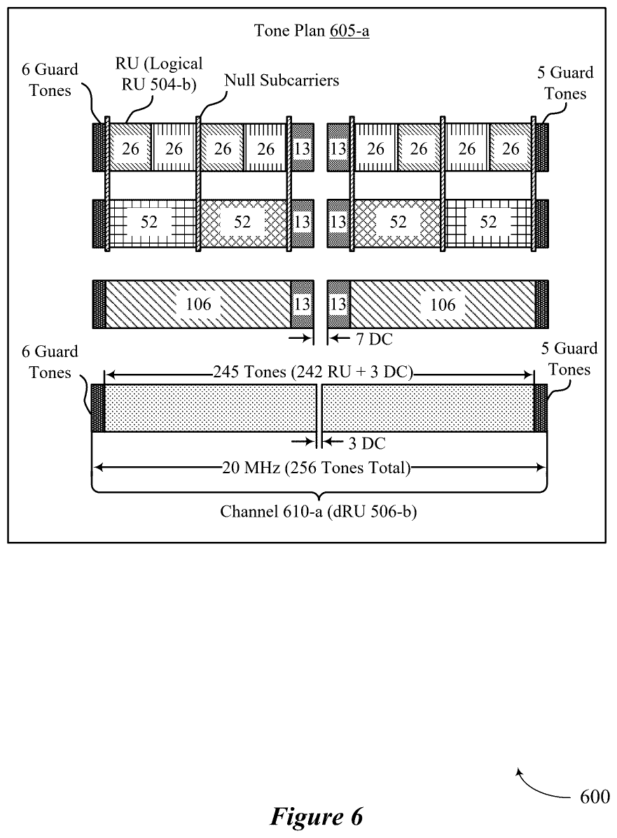

FIG. 6 shows an example of a tone plan diagram 600 that supports transmission of resource units by narrow bandwidth operating devices in wide bandwidth spectrum. Aspects of the tone plan diagram 600 may implement, or be implemented by, aspects of the wireless communication network 100, the PDU 200, the PPDU 350, the PPDU 400, and the frequency diagram 500, as described herein with reference to FIGS. 1-5. For example, the tone plan diagram 600 may illustrate a tone plan 605, such as a tone plan 605-a, which may be used to map one or more tones of one or more rRUs, or for mapping one or more tones of a logical RU 504 to one or more distributed tones for a dRU 506 as illustrated in FIG. 5. The techniques described in the context of the tone plan diagram 600 may enable a wireless device, such as a STA 104, to operate on a narrow bandwidth within a wider bandwidth spectrum.

In some examples, the tone plan 605-a may represent a tone plan for a relatively narrow bandwidth, such as a 20 MHz tone plan that may be supported by a 20 MHz operating wireless device. The tone plan 605-a may illustrate a bandwidth of a channel 610-a, which may in some implementations be a 20 MHz channel with rRUs that may span over 242 tones in a range of [−122:−3, 3:122]. The tone plan 605-a may include a quantity of different sized RUs that may be allocated to different wireless devices for use in communications in a WLAN. For example, the tone plan 605-a may support 26-tone RUs (such as 26-tone regions), 52-tone RUs, 106-tone RUs, or a 242-tone RU. The tone plan 605-a also may support guard tones (such as edge tones) at the edge of the 20 MHz region, which may in some implementations include 6 guard tones on a left side and 5 guard tones on a right side. The tone plan 605-a may further include one or more DC (such as direct current, direct conversion) tones in the middle of a total 245 tones (such as of a total 256 tones of the channel 610-a including guard tones, RU tones, and DC tones). For example, for a 242-tone RU, 3 DC tones may be used, while for RUs with less tones, 7 DC tones may be used, which may split a middle 26-tone RU into two segments of 13 tones each. DC tones in some implementations may represent middle tones, or middle subcarriers, of a channel or tone plan that are not used for transmissions. One or more additionally unused subcarriers may be present, including one or more null subcarriers between one or more of the RUs.

In some examples, the RUs of the tone plan 605-a may be rRUs including one or more contiguous subcarriers, and may be allocated to a STA 104 for transmissions. Additionally, or alternatively, a logical RU 504 may be allocated to a STA 104 for use in transmissions of which one or more tones may be distributed across a wider bandwidth or a larger quantity of tones in a dRU 506. For example, a STA 104 may be allocated a logical RU 504-b of 26 tones and may map the logical RU 504-b to a set of 26 noncontiguous subcarrier indices of the dRU 506-b that may be spread across the 20 MHz wireless channel 610-a (such as spreading bandwidth). In some examples, a STA 104 operating using a 20 MHz channel, such as the channel 610-a and the tone plan 605-a, may not support or operate on wider bandwidths or channels, which may cause one or more data tones in the tone plan defined for the wide PPDU bandwidth to overlap with DC tones of narrow bandwidth operating devices. For example, tones of a wider tone plan that may be different than those of the tone plan 605-a may overlap with one or more DC tones of the dRU 506-b, which may reduce a quality of transmissions (such as may jam some data tones by leakage). Further, one or more procedures may not be defined for allowing narrow bandwidth operating STAs to operate within a wider PPDU bandwidth.

As described herein, a STA 104 may shift a dRU 506 mapped to a narrow distribution bandwidth into a wide PPDU bandwidth to enable transmission. For example, the STA 104 may identify or receive an RU allocation for the logical RU 504-b and may translate a corresponding global RU index into a local RU index for the tone plan 605-a. The STA 104 may map the logical RU 504-b to tones of the dRU 506-b over the corresponding spreading bandwidth (such as distribution bandwidth), such as the 20 MHz channel 610-a. The STA 104 may shift the mapped dRU tones so that the tones may align with the rRU tones that correspond to the distribution BW in a wide PPDU bandwidth, where the location of the distribution BW in the wider PPDU BW is decided based on the global RU index. Additionally, a STA 104 may transmit one or more STFs or LTFs, or may implement a tone plan enabling direct mapping for tones of a spreading bandwidth to tones of a wider PPDU bandwidth.

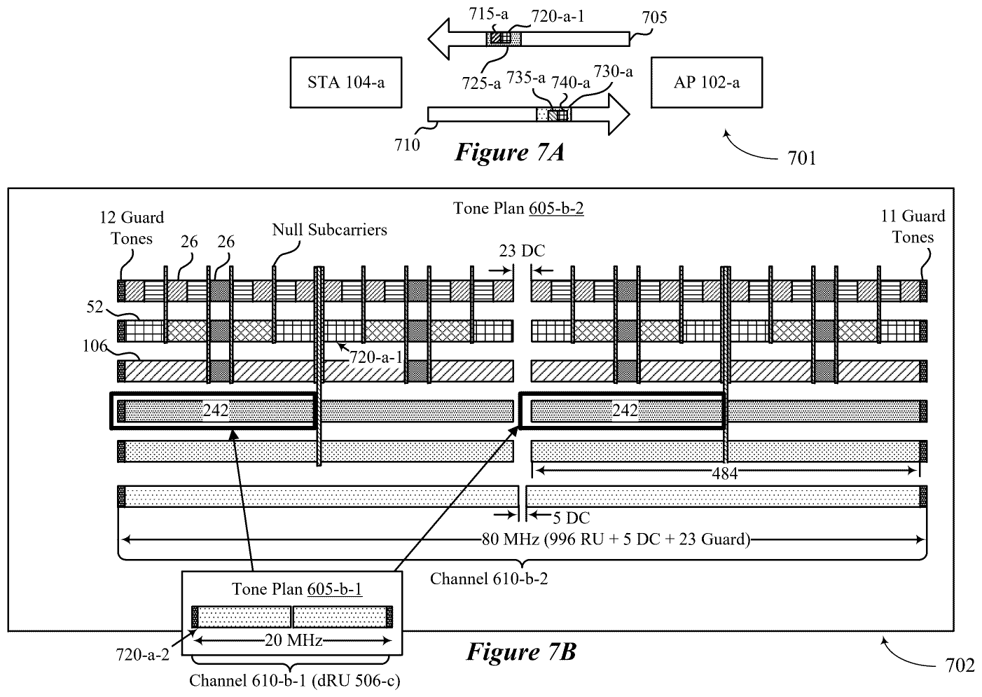

FIGS. 7A and 7B show examples of a signaling diagram 701 and a tone plan diagram 702 that support transmission of resource units by narrow bandwidth operating devices in wide bandwidth spectrum. Aspects of the signaling diagram 701 and the tone plan diagram 702 may implement, or be implemented by, aspects of the wireless communication network 100, the PDU 200, the PPDU 350, the PPDU 400, the frequency diagram 500, and the tone plan diagram 600, as described herein with reference to FIGS. 1-6. For example, the signaling diagram 701 may illustrate an AP 102, such as an AP 102-a, in communication with one or more STAs 104, including communications with a STA 104-a via a downlink communications link 705 and an uplink communications link 710 (such as one or more communications links 106). The tone plan diagram 702 may illustrate one or more tone plans usable by the STA 104-a, including a tone plan 605-b-1 and a tone plan 605-b-2. In some examples, the signaling diagram 701 and the tone plan diagram 702 may support mapping tones to a narrow bandwidth of the tone plan 605-a-1 and shifting the tones into indices of a wider bandwidth of the tone plan 605-a-2 as described herein.

The tone plan 605-b-1 may be an example of the tone plan 605-a illustrated with respect to FIG. 6. For example, the tone plan 605-b-1 may represent a relatively narrow bandwidth tone plan for a channel 610-b-1, which may be, for example, a spreading bandwidth of 20 MHz, 40 MHz, 80 MHz, or another bandwidth (such as for a 20/40/80 MHz tone plan). The tone plan 605-b-2 may represent a relatively wide bandwidth tone plan with a bandwidth of the channel 610-b-2 being wider than that of the channel 610-b-1. For example, the tone plan 605-b-2 may be a tone plan for a PPDU bandwidth of 80 MHZ, 160 MHz, 320 MHz, or another bandwidth. The tone plan 605-b-2 may include a combination of 26-tone RUs, 52-tone RUs, 106-tone RUs, 242-tone RUs, and 484-tone RUs with one or more null subcarriers and 23 DC tones and 12 guard tones at the left and 11 guard tones at the right of the 80 MHz channel 610-b-2. Additionally, or alternatively, the tone plan 605-b-2 may include a 996-tone RU with 5 DC tones and 23 guard tones at edges of the channel.

In some examples, the STA 104-a may shift a dRU 506 over a narrow bandwidth (such as 20 MHz, 40 MHz, 80 MHZ) into a wider PPDU bandwidth (such as 80 MHz, 160 MHz, 320 MHZ) to enable transmission using the wider PPDU bandwidth.

For example, the STA 104-a may identify an RU allocation 715 that may give a global RU index in a PPDU bandwidth. For example, the STA 104-a may identify an RU allocation 715-a and a corresponding RU index 720-a-1, which may be a global RU index corresponding to the 80 MHz channel 610-b-2. In some examples, the STA 104-a may receive the RU allocation 715-a and the RU index 720-a-1 from the AP 102-a, for example, in a control message 725-a. The STA 104-a may translate the RU index 720-a-1 into a local RU index in its corresponding spreading bandwidth (such as distribution bandwidth), such as an RU index 720-a-2 in the 20 MHz bandwidth channel 610-b-1 that may correspond to a position of the global RU index 720-a-1 in the 80 MHz bandwidth.

The global RU index 720-a-1 may correspond to a global location of an RU within the tone plan 605-b-2, while the local RU index 720-b-2 may correspond to a local location of an RU within the tone plan 605-b-1. For example, according to the RU allocation 715-a, the RU52_5 in 80 MHz may be assigned to the 20 MHz operation STA 104-a for distributed transmission so that a dRU may be spread over 20 MHZ instead of the full 80 MHz. The RU allocation 715-a may give a global RU index in the 80 MHz channel 610-b-2, and the STA 104-a may determine where the RU allocation 715-a is placed within a 20 MHz region of the tone plan 605-b-2. In an example, the RU index 720-a-1 may indicate an RU 52_5 in 80 MHz, or a fifth 52-tone RU within the channel 610-b-2. If the RU spreading bandwidth is 20 MHZ (or another narrow bandwidth, such as 40 MHz for a dRU spread over 40 MHz in 80 MHz PPDU), the STA 104-a may translate the global RU index to the local RU index in the dRU spreading bandwidth of 20 MHz. For example, the RU52_5 may be a first 52-tone RU in a 2nd 20 MHz of 80 MHz PPDU bandwidth, and so the STA 104-a may determine a local RU index of 1 (RU52_1) in a second 20 MHz subblock, or subband, of the total 80 MHz channel.

The STA 104-a may map the assigned RU from the RU allocation 715-a to dRU tones over a corresponding distribution bandwidth. For example, the STA 104-a may map 26 tones to a set of 26 noncontiguous subcarrier indices of a dRU 506-c that may include indices of the subcarrier indices spanning the channel 610-b-1. The mapping may be done in accordance with the tone plan 605-b-1. For example, for 20 MHz, dRUs may span over 241 tones in a range of [−120:−2, 2:120], where each dRU may maintain at least (such as ≥) 3 DC tones. The mapping also may be done based on the local RU index. For example, the STA 104-a may map tones to the dRU 506-c over 20 MHz (or to a dRU over 40 MHz or another narrow bandwidth), such as mapping the RU52_1 to dRU52_1 tones in 20 MHz. In such an example, the STA 104-a may select the range of indices for the tone plan 605-b-1 based on the global index 720-a-1 (such as indices corresponding to the RU52_5 of the 80 MHZ). The STA 104-a may convert the global index to the local index RU52_1, and to map the dRU across the 20 MHZ, the STA 104-a may use the local RU52_1 index to select which set of indices (such as [0, 9, 18, . . . ], [4, 13, 22, . . . ]) to map to based on the corresponding RU index (such as R52_1).

After the mapping, the STA 104-a may shift the dRU tones (such as of the user or STA 104-a) into tone indices of the PPDU 80 MHz bandwidth. For example, the STA 104-a may shift to 80 MHz tone indices by shifting the dRU52_1 in 20 MHZ mapped tones into 80 MHz by a shifting value of −133 tones to a frequency location where a second RU242 locates which corresponds to the global RU index 720-a-1. In some examples, shifting may thus represent an operation for the STA 104-a to map an assigned RU to the distributed tone within its spreading bandwidth in wide OFDMA transmission. Shifting may in some implementations be done while preparing one or more OFDM symbols. For example, such shifted OFDM symbols may be passed through an IFFT to be converted to the time domain before transmission, and an IFFT size may be based on the PPDU bandwidth.

In some examples, such shifting may be done for different bandwidths. For example, when a dRU 506 over a narrow bandwidth of 20/40/80 MHz participates in an 40/80/160/320 MHz transmission, a STA may shift the dRU over 20/40/80 MHz into a wide bandwidth OFDMA tone plan as an RU. In some examples, a dRU over 20 MHZ may be shifted into an rRU242 in an 80 MHz bandwidth (such as shown in FIG. 7B), in 40 MHz, in 160 MHz, or in 320 MHz. Similarly, a dRU over 40 MHz may be shifted into an rRU484 in 80/160/320 MHz and a dRU over 80 MHz may be shifted into an rRU996 in 160/320 MHz. Shifting may make tones of a local tone plan, such as the tone plan 605-b-1 and corresponding spreading bandwidth, to be aligned with existing OFDMA operation in both signaling and cause tone plans to be used the same way as rRUs. In some examples, however, edge tone differences may result in different shift numbers between different bandwidth modes. dRUs on frequency subblocks of a wide bandwidth PPDU may be defined as dRUs on 20 MHZ, 40 MHz and 80 MHz PPDU with different shifts (such as constant shifts) as defined in Table 1 below:

TABLE 1

| Freq | | | | |
|---|---|---|---|---|
| Subblock | | | | |
| Size | 40 MHz | 80 MHz | 160 MHz | 320 MHz (BW320) |
| 20 MHz | [−124, | [−380, −133, | [−892, −645, −380, −133, | [−1916, −1669, −1404, −1157, −892, −645, −380, −133, |
| | 123] | 132, 379] | 132, 379, 644, 891] | 132, 379, 644, 891, 1156, 1403, 1668, 1915] |
| 40 MHz | N/A | [−256, 256] | [−768, 256, 256, 768] | [−1792, −1280, −768, −256, 256, 768, 1280, 1792] |
| 80 MHz | N/A | NA | [−512, 512] | [−1536, −512, 512, 1536] |

Notably, each list of shifts for each subblock size and wide bandwidth size (such as of a PPDU bandwidth) may represent a range in tones, and may correspond to subblocks of the subblock size going left to right across the wide bandwidth. For example, as discussed herein, a 20 MHz subblock size or distribution bandwidth in an 80 MHz PPDU bandwidth, for a second 20 MHz subblock, may use a shift of −133 according to Table 1. In some examples, by allowing dRUs within a 242-tone region for each 20 MHz subblock on an 80 MHz, 160 MHz, or 320 MHz block to be shifted accordingly, dRU distribution may be allowed on a 20 MHz subblock to be performed for puncture mode or 20 MHz operating devices, such as the STA 104-a.

After the mapping and shifting, the STA 104-a may transmit a message 730 to the AP 102-a in accordance with the mapping and shifting and related tone plans. For example, the STA 104-a may transmit a message 730-a, such as a PPDU to the AP 102-a.

In some examples, the STA 104-a may transmit an STF 735, such as an STF 735-a. The STF 735 may be STF for an EHT-STF and may be transmitted as part of the PPDU in accordance with the formats described with reference to FIGS. 2 and 3. STFs of dRUs may use STF sequences for corresponding distribution bandwidths. In some examples, a sequence Kr may equal rRU242 for dRUs distributed on 20 MHz bandwidths (BW20), rRU484 for dRUs distributed on 40 MHz bandwidths (BW40), and rRU996 for dRUs distributed on 80 MHz bandwidths. In some examples, basing an STF 735 on a spreading bandwidth may be efficient when a spread bandwidth is equal to a PPDU bandwidth. The STF 735-a may be used to set AGC gain (such as using STF to capture power and calculate power for an RU spreading over 20 MHz) and for DC offset correction. For narrow bandwidth dRUs in wide bandwidth PPDUs, STFs may be based on either the spreading bandwidth or the wide PPDU bandwidth. For example, a dRU tone plan may be based on tone mapping in a distribution bandwidth and shifting into the tone indices of a PPDU bandwidth. Transmitting the STF 735-a sequence may in such an example be similarly based on distribution BW and may involve similar mapping or shifting processes and dRU tones.

In a first option, the STF 735-a may be mapped to indices of the channel 610-b-1 and shifted into the channel 610-b-2 similar to the associated dRUs. In some examples, doing a same mapping and shifting operation as dRU tones for the STF 735-a may result in an STF periodicity being broken, as shift values may not be a multiple of 8. For example, for STF tones mapped to a 20 MHz spectrum, the tones of the STF 735-a may be placed so that stf_tone_sb=[−120:8:−8, 8:8:120]+shift_sb, where shift-_sb may be the shift applied to the STF tones to shift into the 80 MHz spectrum. Notably, the STF 735-a may have an original periodicity of 8, corresponding to an STF tone for each 8 tones. However, if the STF follows different shifts to fit into 20 MHZ (such as RU242) in 80 MHz PPDU spectrum, one or more shifts may not be a multiple of 8, as seen in Table 1. This may result in losing an original multiple of 8 periodicity. However, in some examples, changing (such as breaking) the periodicity may not affect or minimally affect STF performance. For example, at a stage of STF reception, packet detection may already be done, and so periodicity may not affect packet detection. Further, power measurement may not involve STF periodicity. In some examples, DC estimation and subtraction may depend on STF periodicity, however. DC estimation and subtraction in such an example may be replaced by using a DC notch filter (such as that may not be related to STF style). This may be performed at the receiver side (such as at the AP 102-a).

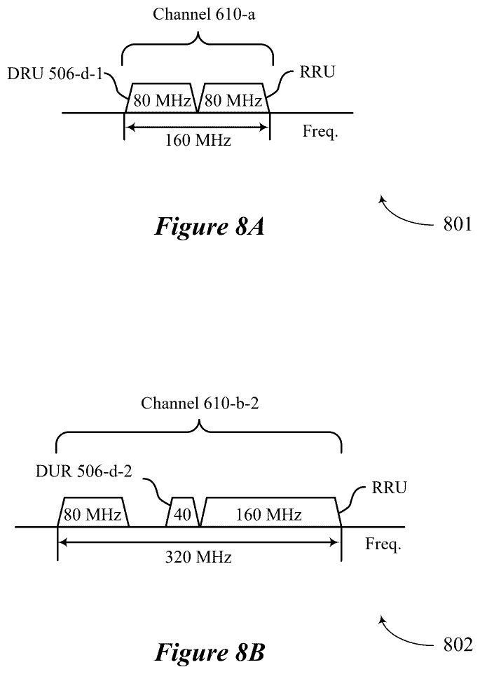

In a second option, the STF 735-a may use a sequence defined for PPDU bandwidth, but STF tones over the spreading bandwidth section of the PPDU bandwidth may be populated without populating those outside of the spreading bandwidth (such as the channel 610-b-1 location as shifted into the channel 610-b-2). For example, the STF sequence of the STF 735-a may depend on PPDU bandwidth, or the 80 MHz bandwidth and channel 610-b-2, while the STF tone set may depend on the distribution bandwidth. This may result in STF periodicity being well maintained. The second option for STF transmission may be further described with respect to FIGS. 8A and 8B.

In some examples, a global CSD may be used to solve unintentional beamforming in STF transmission for dRU. For example, transmitting same STFs for each dRU within a 20 MHz distribution bandwidth of the 80 MHz PPDU spectrum may result in unintentional beamforming that may cause cancellation of one or more signals. Thus, a global CSD may be used locally in each spreading bandwidth so that unintentional beamforming and signal attenuation may be mitigated. In some examples, a global cyclic shift delay (CSD) for the STF 735-a may be applicable within, but not outside of, each spreading bandwidth, such as the 20 MHz channel portion of the channel 610-b-2. A global CSD index (such as associated with the narrow bandwidth and a local dRU index) also may be based on a quantity of users in each spreading bandwidth.

Additionally, the STA 104-a may transmit an LTF 740, such as an LTF 740-a. In some examples, the LTF 740-a may be transmitted as part of the PPDU in accordance with the formats described with reference to FIGS. 2 and 3. A dRU LTF sequence may depend on a spreading bandwidth (such as distribution bandwidth) even for narrow bandwidth dRUs 506 shifted in wide bandwidth PPDUs. LTF tone plans also may involve the same tones as dRU data tones to provide channel estimation. For example, in examples of narrow bandwidth dRU transmission in wide bandwidth PPDUs, such as illustrated in FIG. 7B, dRU LTF tones may be the same as dRU data tones, and may be based on tone mapping in a distribution bandwidth (such as a narrow bandwidth), and shifting the LTF tones into the tone indices of PPDU bandwidth. In some examples, joint optimization of LTF over a PPDU bandwidth may be supported. Additionally, or alternatively, dRU LTFs may exclude joint LTF optimization due to existence of hybrid dRUs and rRUs. For example, LTFs may be defined for each distribution bandwidth with different optimization, where a dRU may use an LTF sequence alone in a distribution bandwidth and shift into tones as dRU data.

FIGS. 8A and 8B show examples of frequency diagrams 801 and 802 that support transmission of resource units by narrow bandwidth operating devices in wide bandwidth spectrum. Aspects of the frequency diagrams 801 and 802 may implement, or be implemented by, aspects of the wireless communication network 100, the PDU 200, the PPDU 350, the PPDU 400, the frequency diagram 500, the tone plan diagram 600, the signaling diagram 701, and the tone plan diagram 720 as described herein with reference to FIGS. 1-7B. For example, the frequency diagrams 801 and 802 may illustrate examples of the second option for STF transmission involving basing an STF sequence on a wider PPDU bandwidth.

For example, an STF sequence may be the same as an EHT-STF (such as an 8 μs EHT-STF). The STF sequence may be chosen based on a dRU spreading bandwidth and a PPDU bandwidth. In some examples, for a hybrid rRU and dRU transmission, an rRU may use a PPDU bandwidth sequence with a same subcarrier index as an assigned RU, while an STF for a dRU may use the STF sequence defined for the PPDU bandwidth with same subcarrier indices as an rRU242 (dRU spreading 20 MHz), an rRU484 (dRU spreading 40 MHZ), an rRU996 (dRU spreading 80 MHZ), or other larger distribution bandwidth. For example, STF tones within a dRU spreading bandwidth may be used for transmission, where, for dRU26 in UHR20 (such as UHR 20 MHz), STF tones may be transmitted in the 20 MHz transmission. Notably, a STA 104 may use an STF sequence based on and for a wider bandwidth, but may utilize tones that fall within the distribution region subblock of the wider PPDU bandwidth.

In the example of FIG. 8A, a dRU 506-d may be a dRU52 involving an RU52 (such as logical RU 504) spread over 80 MHz that is shifted into a 160 MHZ spectrum of a channel 610-c-1 (such as assigned to the left 80 MHZ). An rRU also may be transmitted in a hybrid format in another 80 MHz of the 160 MHz PPDU bandwidth. Transmitting an STF in such a scenario according to the second option may involve using and transmitting a same STF sequence as the first rRU996 in the 160 MHz PPDU bandwidth. However, STF tones that fall within the left segment or subblock of 80 MHz may be used.

Additionally, or alternatively, in the example of FIG. 8B, a dRU 506-d-2 may be an example of a dRU26 involving an RU26 (such as logical RU 504) spread over 40 MHz of a 320 MHz PPDU spectrum of a channel 610-c-2. An rRU also may be transmitted in a hybrid format in a 160 MHz subblock at the right, while 80 MHz at the left may be used for other dRU transmissions. Notably, the dRU 506-d-2 may be assigned to the 40 MHz subblock. Transmitting an STF in such a scenario according to the second option may thus involve transmitting a same STF sequence as the fourth rRU484 in the PPDU 320 MHz bandwidth, where only STF tones within the 40 MHZ may be used. In some examples, using the second option for STF transmission for narrow bandwidth shifted into wider PPDU bandwidths may allow the STF to maintain a periodicity (such as periodicity of 8), which may simplify one or more operations and processing at a receiving device, as well as reduce additional rules and signaling (such as DC estimation and subtraction may not be replaced by a DC notch filter given periodicity may be maintained).

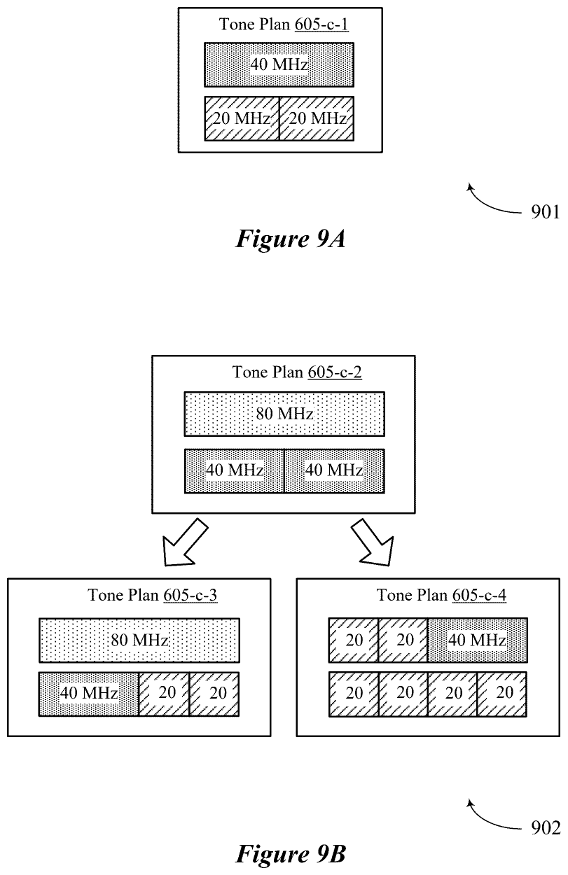

FIGS. 9A and 9B show an example of tone plan diagrams 901 and 902 that support transmission of resource units by narrow bandwidth operating devices in wide bandwidth spectrum. Aspects of the tone plan diagrams 901 and 902 may implement, or be implemented by, aspects of the wireless communication network 100, the PDU 200, the PPDU 350, the PPDU 400, the frequency diagram 500, the tone plan diagram 600, the signaling diagram 701, the tone plan diagram 720, and the frequency diagrams 801 and 802 as described herein with reference to FIGS. 1-8B. For example, the tone plan diagrams 901 and 902 may illustrate examples of tone plans 605 for mapping one or more tones of a logical RU 504 to one or more distributed tones for a dRU 506. In some examples, the tone plan diagrams 901 and 902 may support mapping tones of a dRU directly to indices of a new tone plan for a wider PPDU BW that is segmented into spreading bandwidths (such as distribution bandwidths).

For example, some 20 MHz EHT devices in 40 MHz and above may refrain from transmitting rRU242s, as transmission LO leakage may result in self jamming one or more data tones of the rRU242 (such as damaging one or more tones). Thus, when shifting dRUs that spread over 20 MHz to rRU242 locations in wide bandwidths (such as PPDU spectrum), similar self jamming may result as rRU242s may be transmitted. For example, one or more dRU tones may be damaged by LO leakage or 20 MHz DC leakage (or transmission leakage) as such tones may be near or at one or more DC symbols after being shifted. In an example, in a first 20 MHz within 80 MHz, DC tones may be around a tone index of −384. However, each dRU106 over 20 MHz may include two tones that may be damaged (such as may overlap with DC tones after shifting). Two dRU52s out of four dRU52s over 20 MHz may each include one or more tones next to a sub20 DC (such as a DC tone of a subblock of 20 MHz). Further, three dRU26s out of nine over 20 MHz may each include one or more tones next to or at sub20 DC. Additionally, or alternatively, dRU26_5 may have a tone at −384 after shifting by −380, which may be at a DC of a physical 20 MHz spectrum, thus reducing performance in transmissions. DC offset may in some implementations be random and so may further prevent puncturing.

In some examples, a 20 MHz dRU tone plan for distribution bandwidth of 20 MHz may be defined to keep a same quantity of dRUs as rRUs on BW20 (such as 9 dRU26s, 4 dRU52Ds, 2 dRU106s) with a same format of indexing, ordering, and tone plan table as an rRU, a 20 MHz dRU tone plan may use an RU allocation table for trigger frame setting. A data and pilot subcarrier index table for dRUs in 20 MHz UHR PPDUs may be illustrated in Table 2 below:

TABLE 2
Data and Pilot subcarrier indices for dRUs in 20 MHz UHR PPDU

dRU

| Type | dRU index and subcarrier range | | | | |
|---|---|---|---|---|---|
| 26-tone | DRU1 | DRU2 | DRU3 | DRU4 | DRU5 |
| DRU | [−120:9:−12, | [−116:9:−8, | [−118:9:−10, | [−114:9:−6, | [−112:9:−4, |
| i = 1:9 | 6:9:114] | 10:9:118] | 8:9:116] | 12:9:120] | 5:9:113] |
| | DRU6 | DRU7 | DRU8 | DRU9 | |
| | [−119:9:−11, | [−115:9:−7, | [−117:9:−9, | [−113:9:−5, | |
| | 7:9:115] | 11:9:119] | 9:9:117] | 4:9:112] | |
| 52-tone | DRU1 | | DRU2 | | |
| DRU | 26-tone [DRU1, DRU2] | | 26-tone [DRU3, DRU4] | | |
| i = 1:4 | DRU3 | | DRU4 | | |
| | 26-tone [DRU6, DRU7] | | 26-tone [DRU8, DRU9] | | |
| 106-tone | DRU1 | | DRU2 | | |
| DRU | 26-tone [DRU1~4], [−3, 3] | | 26-tone [DRU6~9], [−2, 2] | | |
| i = 1:2 | | | | | |

Notably, dRU4, dRU5, and dRU9 (such as each a 26 tone RU) may each experience damage to transmissions at indices −6,−4, and −5.

As described herein, one or more tone plans (such as a new ODFMA tone plan) may be defined to facilitate transmission for 20 MHz devices (such as in place of shifting). For example, in a new OFDMA tone plan 605, each 20 MHz or 40 MHz RU may be aligned with a physical 20 MHz or 40 MHz spectrum, so that instead of shifting, a wireless device (such as a STA 104, an AP 102) may utilize a 20 MHz tone plan or 40 MHz tone plan in each 20 MHz subblock (such as sub20 frequency block) or 40 MHz subblock of a wider overall bandwidth.

In the example of FIG. 9A, a tone plan 605-c-1 may be added in addition to or to replace a 40 MHz tone plan (such as 40 MHz OFDMA tone plan). In some examples, the tone plan 605-c-1 may involve a total PPDU bandwidth of 40 MHZ, where two 20 MHz tone plans (such as duplicate 20 MHz OFDMA tone plans) may be used in mapping each 20 MHz subblock of the overall 40 MHz bandwidth. For example, when transmitting a PPDU, a STA 104 may map dRU tones directly to the tones of one of the 20 MHz subblocks using a corresponding 20 MHz tone plan, while other signals may be mapped to the other subblock using a 20 MHz tone plan.

Additionally, or alternatively, in the example of FIG. 9B, a tone plan 605-c-2 may involve 40 MHz tone plans for mapping each 40 MHz subblock of an overall 80 MHz PPDU bandwidth (such as existing tone plan=duplicated 40 MHz OFDMA tone plans). Further, a new tone plan 605-c-3 may split one of the 40 MHz segments into 2×20 MHz subblocks each associated with a 20 MHz tone plan (such as duplicated 20 MHz subblocks). Thus, instead of shifting a mapped 20 MHz dRU 506 into one of the 40 MHz tone plans of the 80 MHz PPDU block, a 20 MHz dRU 506 may be mapped directly to one of the 20 MHz tone plans and corresponding 20 MHz subblock. Additionally, or alternatively, a tone plan 605-c-4 may split a remaining 40 MHz segment further to include four 20 MHz tone plans and corresponding segments (such as allowing direct mapping to any of the 20 MHz subblocks and tone plans).

In some examples, each of the tone plans 605 may include corresponding guard tones (such as edge tones), DC tones, null subcarriers, pilot tones, and data tones. For example, splitting the tone plans into 20 MHz tone plan duplicates may utilize 6 left guard tones and 5 right guard tones, with either 7 DC tones or 3 DC tones, as well as subcarriers and potential RUs as illustrated in FIG. 6, as well as pilot tones and data tones for 20 MHz spectrum.

In some examples, a mask, such as a 20 MHz mask with associated guard tones, DC tones, and null subcarriers, may be associated with the new tone plans 605. As a 20 MHz mask may be more restricting compared to other masks (such as than a 40 MHz mask, a 80 MHz mask), 20 MHz devices that do not support higher frequencies may function properly without additional complexity or expense to satisfy a 40 MHz or 80 MHz mask, even with less quantities of edge tones in the 20 MHz tone plan in each 20 MHz subblock. Further, by allowing direct mapping to subblocks of a wider PPDU bandwidth, DC and LO leakage may be mitigated (such as to the extent that little to no DC or LO leakage may be present). The new OFDMA tone plans also may provide advantages or help for rRU transmission for 20/80 MHz operation devices in wide bandwidth. For example, the same tone plans 605 described may be applied or used for mapping one or more rRUs. For dRU transmissions, STF sequences may be based on spreading bandwidths rather than PPDU bandwidths for narrow bandwidth dRU, as each 20 MHz tone plan may operate independently. Further operations may be considered for RU allocation and other signaling, as well as options to provide compatibility with other OFDMA tone plans as discussed herein. For example, the tone plans 605 may be used in addition to 80 MHz tone plans (such as with 80 MHz defined guard tones) or double 40 MHz tone plans (such as with 40 MHz defined guard tones). In some examples, a STA 104 or AP 102 may select one or more tone plans to use in different situations based on one or more conditions of a network or signaling. Further, although the tone plans 605 may illustrate splitting a 40 MHz bandwidth and an 80 MHz bandwidth, additional tone plans 605 may be considered to split larger bandwidths with related tone plans, and may utilize any combination of smaller tone plans to cover a wider bandwidth.

Further, one or more dRU transmission rules may be defined regarding one or more tone plans 605. For example, during uplink transport block (TB) PPDU transmission, a PPDU bandwidth may be a minimum (such as smallest) bandwidth that covers an rRU size. In a single user (SU) example, if a user is transmitting an RU26, a rule may be defined so that the user may transmit an RU26 over 20 MHz, but not over 40 MHz or larger bandwidths, which may improve efficiency (as otherwise this may lead to an efficiency loss). For an OFDMA example, a schedule may consider efficiency of transmissions and resource assignments when grouping users. For example, in some implementations, two users both being assigned RUs for 20 MHZ transmission may both be assigned to a same 20 MHz block, instead of to separate 20 MHz subblocks, to increase an efficiency of resource assignment and usage. Similar assignments can be made for groupings based on 40 MHz or other frequencies for transmission.

In dRU transmissions, using larger PPDUs or distribution bandwidths may further improve a power gain, but efficiency may be considered by one or more rules or devices. For example, a rule may be defined to avoid efficiency dropping below 25% (such as to achieve a same efficiency as 11be DUP mode). Additionally, or alternatively, a rule may be defined to avoid abusing dRU for SU examples. For example, a user may find even greater power gain across a wider bandwidth (such as by spreading over 40 MHz instead of 20 MHz). In some examples, one or more rules may reduce “selfish” behavior or dRU abuse, for example, by restricting devices to use dRU26 distributed over 20 MHz, but not greater than 20 MHz, to avoid tone inefficiency. Unpopulated tones may be transmitted by other users as well. In some examples, an SU may spread a bandwidth up to 4 times in DUP mode for rRU transmission. Similar rules and limitations may thus be set for dRU transmission.

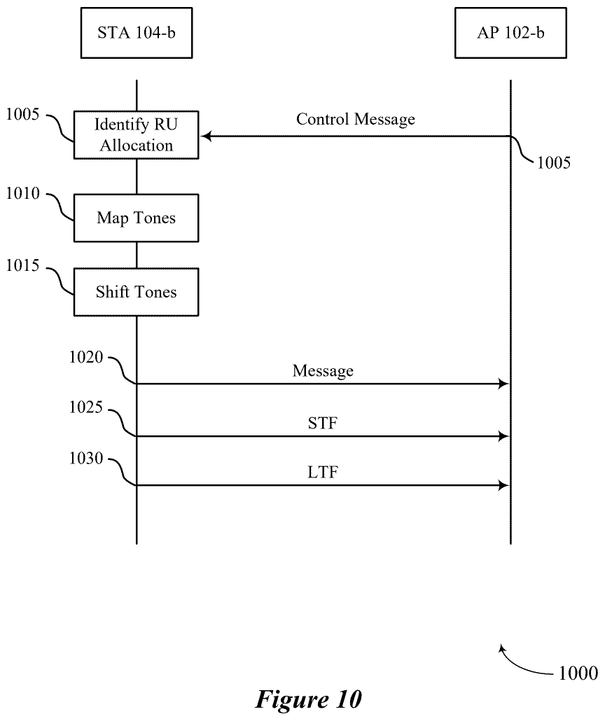

FIG. 10 shows an example of a process flow 1000 that supports transmission of resource units by narrow bandwidth operating devices in wide bandwidth spectrum. Aspects of the process flow 1000 may implement, or be implemented by, aspects of the wireless communication network 100, the PDU 200, the PPDU 350, the PPDU 400, the frequency diagram 500, the tone plan diagram 600, the signaling diagram 701, the tone plan diagram 720, the frequency diagrams 801 and 802, and the tone plan diagrams 901 and 902 as described herein with reference to FIGS. 1-9B. For example, the process flow 1000 may include an AP 102, such as an AP 102-b, in communication with one or more STAs 104, such as a STA 104-b, and may illustrate mapping and shifting tones of a narrow bandwidth dRU into a wide PPDU spectrum.

In the following description of the process flow 1000, the operations may be performed (such as reported or provided) in a different order than the order shown, or the operations performed by the example devices may be performed in different orders or at different times. Some operations also may be omitted from the process flow 1000, or other operations may be added to the process flow 1000. Further, although some operations or signaling may be shown to occur at different times for discussion purposes, these operations may actually occur at the same time or at least partially concurrently.

At 1005, the STA 104-b may identify an RU allocation for the STA 104-b including a first RU index, the first RU index associated with a first channel of a first bandwidth. In some examples, the AP 102-b may transmit, and the STA 104-b may receive, a control message indicating the RU allocation for the STA 104-b including the first RU index.

At 1010, the STA 104-b may map a quantity of N tones to a first set of N non-contiguous subcarrier indices of a set of multiple of subcarrier indices spanning a second channel of a second bandwidth less than the first bandwidth. The first set of N subcarrier indices may be selected from a set of multiple sets of N subcarrier indices of the second bandwidth based on a second RU index that corresponds to a position of the first RU index mapped to the second bandwidth.

At 1015, the STA 104-b may shift the mapped N tones to a second set of N subcarrier indices of the first channel according to a shifting value associated with the first RU index, and the second bandwidth. In some examples, the first bandwidth may include an 80 MHz bandwidth and the second bandwidth may include a 20 MHz bandwidth or a 40 MHz bandwidth. Additionally, or alternatively, the RU allocation may be based on a capability of the STA 104-b.

At 1020, the STA 104-b may transmit, and the AP 102-b may receive, a message over the first channel based on the mapping of the N tones and the shifting. For example, the STA 104-b may convert the symbols for the shifted N tones to a time domain using an IFFT function of a size corresponding to the first bandwidth (such as quantity of tones in the first bandwidth). The AP 102-b may receive and demap the tones of the message based on the shifted N tones within the first bandwidth.

At 1025, the STA 104-b may transmit, and the AP 102-b may receive, an STF over the first channel using one or more STF tones based on the mapping.

In some examples, a sequence and tone plan of the STF may be based on (such as associated with) the second channel of the second bandwidth. Transmitting the STF may be based on shifting the STF tones to subcarrier indices of the first channel according to a shifting value associated with the first RU index and the second bandwidth. Additionally, or alternatively, a sequence of the STF may be based on the first bandwidth, and transmitting the STF may be based on mapping a set of multiple STF tones to one or more subcarrier indices distributed across the first channel and using the one or more STF tones that are within the second channel and that are of the set of multiple STF tones. In some examples, transmitting the STF may be in accordance with a CSD with a global CSD index associated with the second RU index.

At 1030, the STA 104-b may transmit, and the AP 102-b may receive, an LTF over the first channel using one or more LTF tones based on the mapping, where a sequence of the LTF may be based on the second bandwidth, and wherein transmitting the LTF may be based on mapping the one or more LTF tones to one or more subcarrier indices of the set of multiple subcarrier indices spanning the second channel, and shifting the mapped LTF tones.

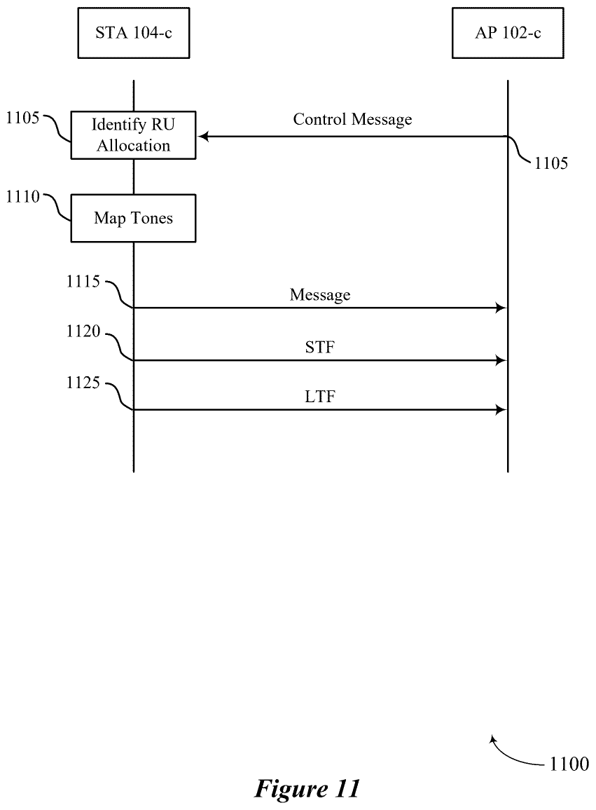

FIG. 11 shows an example of a process flow 1100 that supports transmission of resource units by narrow bandwidth operating devices in wide bandwidth spectrum. Aspects of the process flow 1100 may implement, or be implemented by, aspects of the wireless communication network 100, the PDU 200, the PPDU 350, the PPDU 400, the frequency diagram 500, the tone plan diagram 600, the signaling diagram 701, the tone plan diagram 720, the frequency diagrams 801 and 802, the tone plan diagrams 901 and 902, and the process flow 1000 as described herein with reference to FIGS. 1-10. For example, the process flow 1100 may include an AP 102, such as an AP 102-c, in communication with one or more STAs 104, such as a STA 104-c, and may illustrate mapping tones of a narrow bandwidth dRU into a wide PPDU spectrum directly using one or more tone plans with subblocks the size of spreading (such as distribution) bandwidths.

In the following description of the process flow 1100, the operations may be performed (such as reported or provided) in a different order than the order shown, or the operations performed by the example devices may be performed in different orders or at different times. Some operations also may be omitted from the process flow 1100, or other operations may be added to the process flow 1100. Further, although some operations or signaling may be shown to occur at different times for discussion purposes, these operations may actually occur at the same time or at least partially concurrently.

At 1105, the STA 104-c may identify an RU allocation for the STA 104-c and a first RU index, the first RU index associated with a first channel of a first bandwidth, and the RU allocation indicating a second channel of a second bandwidth. Additionally, or alternatively, the RU allocation may be based on a capability of the STA 104-c. The STA 104-c also may receive, and the AP 102-c may transmit, a control message indicating the RU allocation and the first RU index.

At 1110, the STA 104-c may map a quantity of N tones to a first set of N subcarrier indices of a set of multiple subcarrier indices spanning a frequency subblock of the first channel in accordance with a tone plan associated with the subblock, the subblock of a second bandwidth less than the first bandwidth and including a quantity of M tones that is greater than the quantity of N tones. In some examples, the first channel may include more than one subblock, each subblock of the more than one subblock including a DC subcarrier and one or more guard tones (such as edge tones) at edges of the subblock.

The tone plan associated with the subblock may in some implementations be different than a second tone plan associated with a second subblock of the first channel, and the second subblock may be of a third bandwidth different from the first bandwidth and the second bandwidth. In such an example, the first bandwidth may include an 80 MHz bandwidth, the second bandwidth may include a 20 MHz bandwidth, and the third bandwidth may include a 40 MHz bandwidth. Additionally, or alternatively, the first channel may include four subblocks including the subblock and where each of the four subblocks may be associated with the tone plan. In such an example, the first bandwidth may include an 80 MHz bandwidth and the second bandwidth may include a 20 MHz bandwidth. Additionally, or alternatively, the first channel may include two subblocks including the subblock and where each of the two subblocks may be associated with the tone plan. In such an example, the first bandwidth may include a 40 MHz bandwidth and the second bandwidth may include a 20 MHz bandwidth.

At 1115, the STA 104-c may transmit, and the AP 102-c may receive, a message over the first channel based on the mapping of the N tones in accordance with the tone plan. Additionally, or alternatively, the STA 104-c may transmit an STF at 1120 and an LTF at 1125. In some examples, the STF may be based on the second channel and may be mapped similar to the mapping of the message. The LTF may similarly be based on the second channel and mapped similar to the mapping of the message. The AP 102-c may receive and demap the tones of the message based on the shifted N tones within the first bandwidth according to the tone plan.

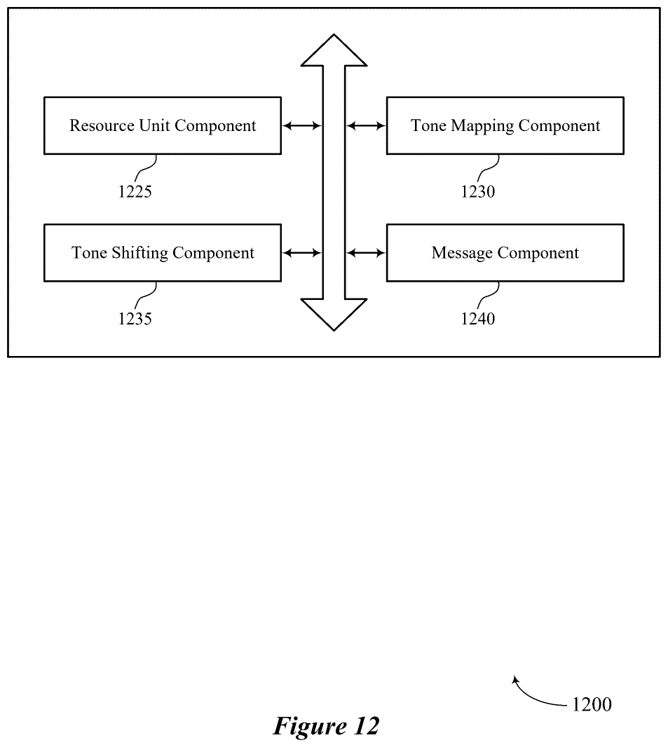

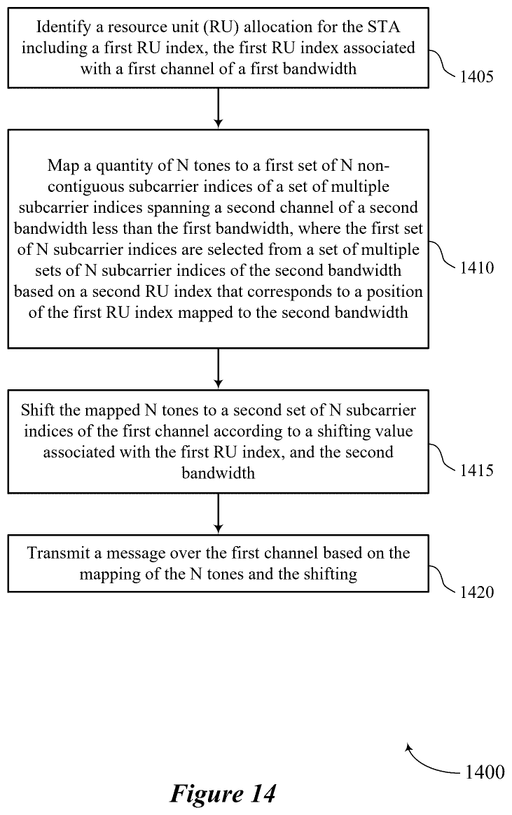

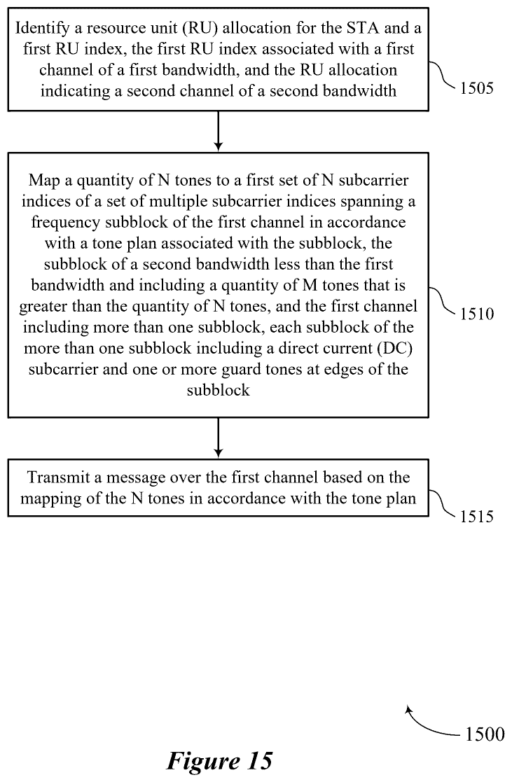

FIG. 12 shows a block diagram of an example wireless communication device 1200 that supports transmission of resource units by narrow bandwidth operating devices in wide bandwidth spectrum. In some examples, the wireless communication device 1200 is configured to perform the processes 1400 and 1500 described with reference to FIGS. 14 and 15, respectively. The wireless communication device 1200 may include one or more chips, SoCs, chipsets, packages, components or devices that individually or collectively constitute or include a processing system. The processing system may interface with other components of the wireless communication device 1200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1200 may transmit the information output from the chip. In such an example, the second interface may refer to an interface between the processing system of the chip and a reception component, such that the wireless communication device 1200 may receive information that is then passed to the processing system. In some such examples, the first interface also may obtain information, such as from the transmission component, and the second interface also may output information, such as to the reception component.

The processing system of the wireless communication device 1200 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1200 can be configurable or configured for use in a STA, such as the STA 104 described with reference to FIG. 1. In some other examples, the wireless communication device 1200 can be a STA that includes such a processing system and other components including multiple antennas. The wireless communication device 1200 is capable of transmitting and receiving wireless communications in the form of, for example, wireless packets. For example, the wireless communication device 1200 can be configurable or configured to transmit and receive packets in the form of physical layer PPDUs and MPDUs conforming to one or more of the IEEE 802.11 family of wireless communication protocol standards. In some other examples, the wireless communication device 1200 can be configurable or configured to transmit and receive signals and communications conforming to one or more 3GPP specifications including those for 5G NR or 6G. In some examples, the wireless communication device 1200 also includes or can be coupled with one or more application processors which may be further coupled with one or more other memories. In some examples, the wireless communication device 1200 further includes a user interface (UI) (such as a touchscreen or keypad) and a display, which may be integrated with the UI to form a touchscreen display that is coupled with the processing system. In some examples, the wireless communication device 1200 may further include one or more sensors such as, for example, one or more inertial sensors, accelerometers, temperature sensors, pressure sensors, or altitude sensors, that are coupled with the processing system.

The wireless communication device 1200 includes a resource unit component 1225, a tone mapping component 1230, a tone shifting component 1235, and a message component 1240. Portions of one or more of the resource unit component 1225, the tone mapping component 1230, the tone shifting component 1235, and the message component 1240 may be implemented at least in part in hardware or firmware. For example, one or more of the resource unit component 1225, the tone mapping component 1230, the tone shifting component 1235, and the message component 1240 may be implemented at least in part by at least a processor or a modem. In some examples, portions of one or more of the resource unit component 1225, the tone mapping component 1230, the tone shifting component 1235, and the message component 1240 may be implemented at least in part by a processor and software in the form of processor-executable code stored in memory.

The wireless communication device 1200 may support wireless communications in accordance with examples as disclosed herein. The resource unit component 1225 is configurable or configured to identify an RU allocation for the STA including a first RU index, the first RU index associated with a first channel of a first bandwidth. The tone mapping component 1230 is configurable or configured to map a quantity of N tones to a first set of N non-contiguous subcarrier indices of a set of multiple subcarrier indices spanning a second channel of a second bandwidth less than the first bandwidth, where the first set of N subcarrier indices are selected from a set of multiple sets of N subcarrier indices of the second bandwidth based on a second RU index that corresponds to a position of the first RU index mapped to the second bandwidth. The tone shifting component 1235 is configurable or configured to shift the mapped N tones to a second set of N subcarrier indices of the first channel according to a shifting value associated with the first RU index, and the second bandwidth. The message component 1240 is configurable or configured to transmit a message over the first channel based on the mapping of the N tones and the shifting.

In some examples, the message component 1240 is configurable or configured to transmit an STF over the first channel using one or more STF tones based on the mapping. In some examples, a sequence and tone plan of the STF are based on the second channel of the second bandwidth. In some examples, transmitting the STF is based on shifting the STF tones to subcarrier indices of the first channel according to a shifting value associated with the first RU index and the second bandwidth. In some examples, a sequence of the STF is based on the first bandwidth. In some examples, transmitting the STF is based on mapping a set of multiple STF tones to one or more subcarrier indices distributed across the first channel and using the one or more STF tones that are within the second channel and that are of the set of multiple STF tones. In some examples, transmitting the STF is in accordance with a CSD with a global CSD index associated with the second RU index.

In some examples, the message component 1240 is configurable or configured to transmit an LTF over the first channel using one or more LTF tones based on the mapping, where a sequence of the LTF is based on the second bandwidth, and where transmitting the LTF is based on mapping the one or more LTF tones to one or more subcarrier indices of the set of multiple subcarrier indices spanning the second channel, and shifting the mapped LTF tones. In some examples, the first bandwidth includes an 80 MHz bandwidth and the second bandwidth includes a 20 MHz bandwidth or a 40 MHz bandwidth. In some examples, the RU allocation is based on a capability of the STA.

Additionally, or alternatively, the wireless communication device 1200 may support wireless communications in accordance with examples as disclosed herein. In some examples, the resource unit component 1225 is configurable or configured to identify an RU allocation for the STA and a first RU index, the first RU index associated with a first channel of a first bandwidth, and the RU allocation indicating a second channel of a second bandwidth. In some examples, the tone mapping component 1230 is configurable or configured to map a quantity of N tones to a first set of N subcarrier indices of a set of multiple subcarrier indices spanning a frequency subblock of the first channel in accordance with a tone plan associated with the subblock, the subblock of a second bandwidth less than the first bandwidth and including a quantity of M tones that is greater than the quantity of N tones, and the first channel including more than one subblock, each subblock of the more than one subblock including a DC subcarrier and one or more guard tones at edges of the subblock. In some examples, the message component 1240 is configurable or configured to transmit a message over the first channel based on the mapping of the N tones in accordance with the tone plan.

In some examples, the tone plan associated with the subblock is different than a second tone plan associated with a second subblock of the first channel, the second subblock of a third bandwidth different from the first bandwidth and the second bandwidth. In some examples, the first bandwidth includes an 80 MHz bandwidth, the second bandwidth includes a 20 MHz bandwidth, and the third bandwidth includes a 40 MHz bandwidth. In some examples, the first channel includes four subblocks including the subblock. In some examples, each of the four subblocks is associated with the tone plan. In some examples, the first bandwidth includes an 80 MHz bandwidth and the second bandwidth includes a 20 MHz bandwidth. In some examples, the first channel includes two subblocks including the subblock. In some examples, each of the two subblocks is associated with the tone plan. In some examples, the first bandwidth includes a 40 MHz bandwidth and the second bandwidth includes a 20 MHz bandwidth. In some examples, the RU allocation is based on a capability of the STA.

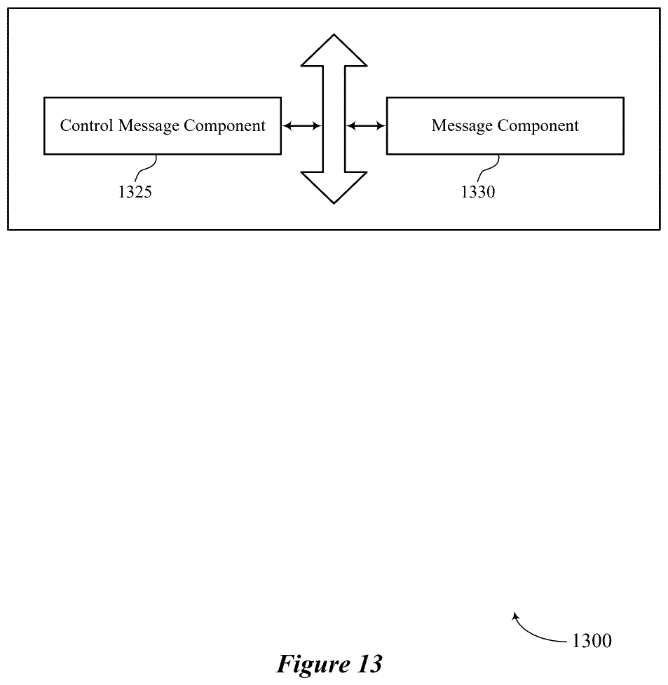

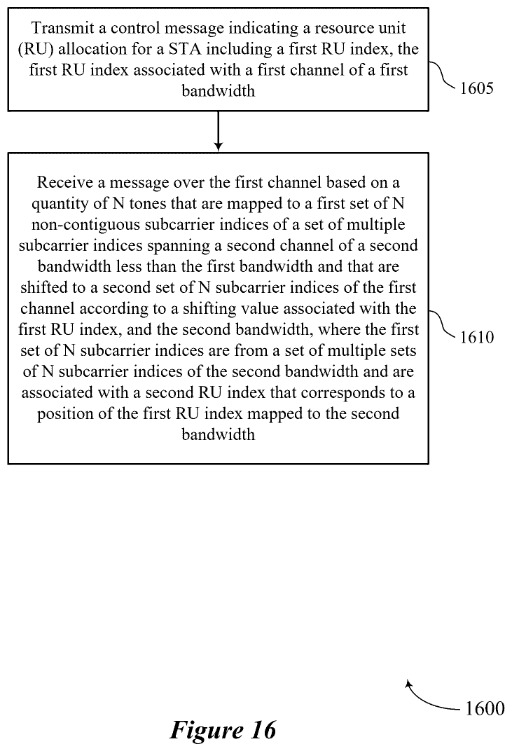

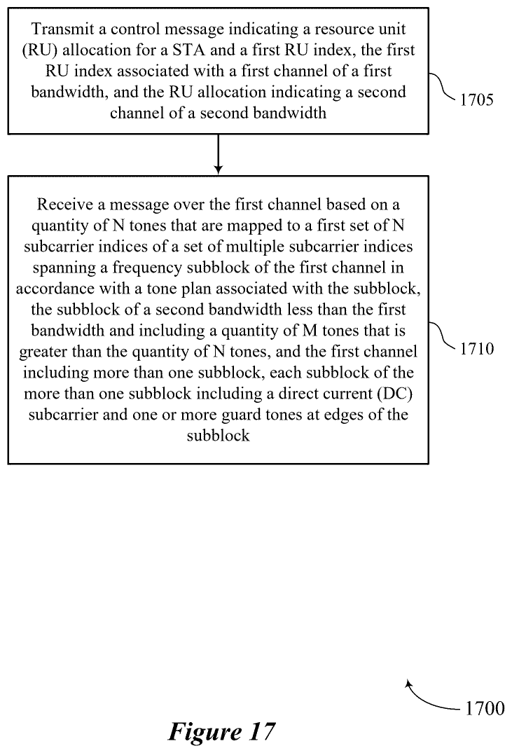

FIG. 13 shows a block diagram of an example wireless communication device 1300 that supports transmission of resource units by narrow bandwidth operating devices in wide bandwidth spectrum. In some examples, the wireless communication device 1300 is configured to perform the processes 1600 and 1700 described with reference to FIGS. 16 and 17, respectively. The wireless communication device 1300 may include one or more chips, SoCs, chipsets, packages, components or devices that individually or collectively constitute or include a processing system. The processing system may interface with other components of the wireless communication device 1300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1300 may transmit the information output from the chip. In such an example, the second interface may refer to an interface between the processing system of the chip and a reception component, such that the wireless communication device 1300 may receive information that is then passed to the processing system. In some such examples, the first interface also may obtain information, such as from the transmission component, and the second interface also may output information, such as to the reception component.

The processing system of the wireless communication device 1300 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1300 can be configurable or configured for use in an AP, such as the AP 102 described with reference to FIG. 1. In some other examples, the wireless communication device 1300 can be an AP that includes such a processing system and other components including multiple antennas. The wireless communication device 1300 is capable of transmitting and receiving wireless communications in the form of, for example, wireless packets. For example, the wireless communication device 1300 can be configurable or configured to transmit and receive packets in the form of physical layer PPDUs and MPDUs conforming to one or more of the IEEE 802.11 family of wireless communication protocol standards. In some other examples, the wireless communication device 1300 can be configurable or configured to transmit and receive signals and communications conforming to one or more 3GPP specifications including those for 5G NR or 6G. In some examples, the wireless communication device 1300 also includes or can be coupled with one or more application processors which may be further coupled with one or more other memories. In some examples, the wireless communication device 1300 further includes at least one external network interface coupled with the processing system that enables communication with a core network or backhaul network that enables the wireless communication device 1300 to gain access to external networks including the Internet.

The wireless communication device 1300 includes a control message component 1325 and a message component 1330. Portions of one or more of the control message component 1325 and the message component 1330 may be implemented at least in part in hardware or firmware. For example, one or more of the control message component 1325 and the message component 1330 may be implemented at least in part by at least a processor or a modem. In some examples, portions of one or more of the control message component 1325 and the message component 1330 may be implemented at least in part by a processor and software in the form of processor-executable code stored in memory.

The wireless communication device 1300 may support wireless communications in accordance with examples as disclosed herein. The control message component 1325 is configurable or configured to transmit a control message indicating an RU allocation for a STA including a first RU index, the first RU index associated with a first channel of a first bandwidth. The message component 1330 is configurable or configured to receive a message over the first channel based on a quantity of N tones that are mapped to a first set of N non-contiguous subcarrier indices of a set of multiple subcarrier indices spanning a second channel of a second bandwidth less than the first bandwidth and that are shifted to a second set of N subcarrier indices of the first channel according to a shifting value associated with the first RU index, and the second bandwidth, where the first set of N subcarrier indices are from a set of multiple sets of N subcarrier indices of the second bandwidth and are associated with a second RU index that corresponds to a position of the first RU index mapped to the second bandwidth.

In some examples, the message component 1330 is configurable or configured to receive an STF over the first channel using one or more STF tones based on the mapping. In some examples, a sequence and tone plan of the STF are associated with the second channel of the second bandwidth. In some examples, receiving the STF includes receiving the STF tones that are shifted to subcarrier indices of the first channel according to a shifting value associated with the first RU index and the second bandwidth. In some examples, a sequence of the STF is associated with the first bandwidth. In some examples, receiving the STF is based on a set of multiple STF tones that are mapped to one or more subcarrier indices distributed across the first channel and using the one or more STF tones that are within the second channel and that are of the set of multiple STF tones. In some examples, receiving the STF is in accordance with a CSD with a global CSD index associated with the second RU index.

In some examples, the message component 1330 is configurable or configured to receive an LTF over the first channel using one or more LTF tones based on the mapping of the N tones, where a sequence of the LTF is associated with the second bandwidth, and where receiving the LTF is based on one or more LTF tones that are mapped to one or more subcarrier indices of the set of multiple subcarrier indices spanning the second channel and that are shifted. In some examples, the first bandwidth includes an 80 MHz bandwidth and the second bandwidth includes a 20 MHZ bandwidth or a 40 MHz bandwidth. In some examples, the RU allocation is based on a capability of the STA.

Additionally, or alternatively, the wireless communication device 1300 may support wireless communications in accordance with examples as disclosed herein. In some examples, the control message component 1325 is configurable or configured to transmit a control message indicating an RU allocation for a STA and a first RU index, the first RU index associated with a first channel of a first bandwidth, and the RU allocation indicating a second channel of a second bandwidth. In some examples, the message component 1330 is configurable or configured to receive a message over the first channel based on a quantity of N tones that are mapped to a first set of N subcarrier indices of a set of multiple subcarrier indices spanning a frequency subblock of the first channel in accordance with a tone plan associated with the subblock, the subblock of a second bandwidth less than the first bandwidth and including a quantity of M tones that is greater than the quantity of N tones, and the first channel including more than one subblock, each subblock of the more than one subblock including a DC subcarrier and one or more guard tones at edges of the subblock.

In some examples, the tone plan associated with the subblock is different than a second tone plan associated with a second subblock of the first channel, the second subblock of a third bandwidth different from the first bandwidth and the second bandwidth.

In some examples, the first bandwidth includes an 80 MHz bandwidth, the second bandwidth includes a 20 MHz bandwidth, and the third bandwidth includes a 40 MHz bandwidth. In some examples, the first channel includes four subblocks including the subblock. In some examples, each of the four subblocks is associated with the tone plan. In some examples, the first bandwidth includes an 80 MHz bandwidth and the second bandwidth includes a 20 MHz bandwidth. In some examples, the first channel includes two subblocks including the subblock. In some examples, each of the two subblocks is associated with the tone plan. In some examples, the first bandwidth includes a 40 MHz bandwidth and the second bandwidth includes a 20 MHz bandwidth. In some examples, the RU allocation is based on a capability of the STA.

FIG. 14 shows a flowchart illustrating an example process 1400 performable by or at a STA that supports transmission of resource units by narrow bandwidth operating devices in wide bandwidth spectrum. The operations of the process 1400 may be implemented by a STA or its components as described herein. For example, the process 1400 may be performed by a wireless communication device, such as the wireless communication device 1200 described with reference to FIG. 12, operating as or within a wireless STA. In some examples, the process 1400 may be performed by a wireless STA, such as one of the STAs 104 described with reference to FIG. 1.

In some examples, in 1405, the STA may identify an RU allocation for the STA including a first RU index, the first RU index associated with a first channel of a first bandwidth. The operations of 1405 may be performed in accordance with examples as disclosed herein. In some implementations, aspects of the operations of 1405 may be performed by a resource unit component 1225 as described with reference to FIG. 12.

In some examples, in 1410, the STA may map a quantity of N tones to a first set of N non-contiguous subcarrier indices of a set of multiple subcarrier indices spanning a second channel of a second bandwidth less than the first bandwidth, where the first set of N subcarrier indices are selected from a set of multiple sets of N subcarrier indices of the second bandwidth based on a second RU index that corresponds to a position of the first RU index mapped to the second bandwidth. The operations of 1410 may be performed in accordance with examples as disclosed herein. In some implementations, aspects of the operations of 1410 may be performed by a tone mapping component 1230 as described with reference to FIG. 12.

In some examples, in 1415, the STA may shift the mapped N tones to a second set of N subcarrier indices of the first channel according to a shifting value associated with the first RU index, and the second bandwidth. The operations of 1415 may be performed in accordance with examples as disclosed herein. In some implementations, aspects of the operations of 1415 may be performed by a tone shifting component 1235 as described with reference to FIG. 12.

In some examples, in 1420, the STA may transmit a message over the first channel based on the mapping of the N tones and the shifting. The operations of 1420 may be performed in accordance with examples as disclosed herein. In some implementations, aspects of the operations of 1420 may be performed by a message component 1240 as described with reference to FIG. 12.

FIG. 15 shows a flowchart illustrating an example process 1500 performable by or at a STA that supports transmission of resource units by narrow bandwidth operating devices in wide bandwidth spectrum. The operations of the process 1500 may be implemented by a STA or its components as described herein. For example, the process 1500 may be performed by a wireless communication device, such as the wireless communication device 1200 described with reference to FIG. 12, operating as or within a wireless STA. In some examples, the process 1500 may be performed by a wireless STA, such as one of the STAs 104 described with reference to FIG. 1.

In some examples, in 1505, the STA may identify an RU allocation for the STA and a first RU index, the first RU index associated with a first channel of a first bandwidth, and the RU allocation indicating a second channel of a second bandwidth. The operations of 1505 may be performed in accordance with examples as disclosed herein. In some implementations, aspects of the operations of 1505 may be performed by a resource unit component 1225 as described with reference to FIG. 12.

In some examples, in 1510, the STA may map a quantity of N tones to a first set of N subcarrier indices of a set of multiple subcarrier indices spanning a frequency subblock of the first channel in accordance with a tone plan associated with the subblock, the subblock of a second bandwidth less than the first bandwidth and including a quantity of M tones that is greater than the quantity of N tones, and the first channel including more than one subblock, each subblock of the more than one subblock including a DC subcarrier and one or more guard tones at edges of the subblock. The operations of 1510 may be performed in accordance with examples as disclosed herein. In some implementations, aspects of the operations of 1510 may be performed by a tone mapping component 1230 as described with reference to FIG. 12.

In some examples, in 1515, the STA may transmit a message over the first channel based on the mapping of the N tones in accordance with the tone plan. The operations of 1515 may be performed in accordance with examples as disclosed herein. In some implementations, aspects of the operations of 1515 may be performed by a message component 1240 as described with reference to FIG. 12.

FIG. 16 shows a flowchart illustrating an example process 1600 performable by or at an AP that supports transmission of resource units by narrow bandwidth operating devices in wide bandwidth spectrum. The operations of the process 1600 may be implemented by an AP or its components as described herein. For example, the process 1600 may be performed by a wireless communication device, such as the wireless communication device 1300 described with reference to FIG. 13, operating as or within a wireless AP. In some examples, the process 1600 may be performed by a wireless AP, such as one of the APs 102 described with reference to FIG. 1.

In some examples, in 1605, the AP may transmit a control message indicating an RU allocation for a STA including a first RU index, the first RU index associated with a first channel of a first bandwidth. The operations of 1605 may be performed in accordance with examples as disclosed herein. In some implementations, aspects of the operations of 1605 may be performed by a control message component 1325 as described with reference to FIG. 13.

In some examples, in 1610, the AP may receive a message over the first channel based on a quantity of N tones that are mapped to a first set of N non-contiguous subcarrier indices of a set of multiple subcarrier indices spanning a second channel of a second bandwidth less than the first bandwidth and that are shifted to a second set of N subcarrier indices of the first channel according to a shifting value associated with the first RU index, and the second bandwidth, where the first set of N subcarrier indices are from a set of multiple sets of N subcarrier indices of the second bandwidth and are associated with a second RU index that corresponds to a position of the first RU index mapped to the second bandwidth. The operations of 1610 may be performed in accordance with examples as disclosed herein. In some implementations, aspects of the operations of 1610 may be performed by a message component 1330 as described with reference to FIG. 13.

FIG. 17 shows a flowchart illustrating an example process 1700 performable by or at an AP that supports transmission of resource units by narrow bandwidth operating devices in wide bandwidth spectrum. The operations of the process 1700 may be implemented by an AP or its components as described herein. For example, the process 1700 may be performed by a wireless communication device, such as the wireless communication device 1300 described with reference to FIG. 13, operating as or within a wireless AP. In some examples, the process 1700 may be performed by a wireless AP, such as one of the APs 102 described with reference to FIG. 1.

In some examples, in 1705, the AP may transmit a control message indicating an RU allocation for a STA and a first RU index, the first RU index associated with a first channel of a first bandwidth, and the RU allocation indicating a second channel of a second bandwidth. The operations of 1705 may be performed in accordance with examples as disclosed herein. In some implementations, aspects of the operations of 1705 may be performed by a control message component 1325 as described with reference to FIG. 13.

In some examples, in 1710, the AP may receive a message over the first channel based on a quantity of N tones that are mapped to a first set of N subcarrier indices of a set of multiple subcarrier indices spanning a frequency subblock of the first channel in accordance with a tone plan associated with the subblock, the subblock of a second bandwidth less than the first bandwidth and including a quantity of M tones that is greater than the quantity of N tones, and the first channel including more than one subblock, each subblock of the more than one subblock including a DC subcarrier and one or more guard tones at edges of the subblock. The operations of 1710 may be performed in accordance with examples as disclosed herein. In some implementations, aspects of the operations of 1710 may be performed by a message component 1330 as described with reference to FIG. 13.

Implementation examples are described in the following numbered clauses: The following provides an overview of aspects of the present disclosure:

Aspect 1: A method for wireless communications by a STA, including: identifying an RU allocation for the STA including a first RU index, the first RU index associated with a first channel of a first bandwidth; mapping a quantity of N tones to a first set of N non-contiguous subcarrier indices of a plurality of subcarrier indices spanning a second channel of a second bandwidth less than the first bandwidth, where the first set of N subcarrier indices are selected from a plurality of sets of N subcarrier indices of the second bandwidth based at least in part on a second RU index that corresponds to a position of the first RU index mapped to the second bandwidth; shifting the mapped N tones to a second set of N subcarrier indices of the first channel according to a shifting value associated with the first RU index, and the second bandwidth; and transmitting a message over the first channel based on the mapping of the N tones and the shifting.

Aspect 2: The method of aspect 1, further including: transmitting an STF over the first channel using one or more STF tones based at least in part on the mapping.

Aspect 3: The method of aspect 2, where a sequence and tone plan of the STF are based at least in part on the second channel of the second bandwidth, and transmitting the STF is based on shifting the STF tones to subcarrier indices of the first channel according to a shifting value associated with the first RU index and the second bandwidth.

Aspect 4: The method of any of aspects 2-3, where a sequence of the STF is based at least in part on the first bandwidth, and transmitting the STF is based at least in part on mapping a plurality of STF tones to one or more subcarrier indices distributed across the first channel and using the one or more STF tones that are within the second channel and that are of the plurality of STF tones.

Aspect 5: The method of any of aspects 2-4, where transmitting the STF is in accordance with a CSD with a global CSD index associated with the second RU index.

Aspect 6: The method of any of aspects 1-5, further including: transmitting an LTF over the first channel using one or more LTF tones based at least in part on the mapping, where a sequence of the LTF is based at least in part on the second bandwidth, and where transmitting the LTF is based at least in part on mapping the one or more LTF tones to one or more subcarrier indices of the plurality of subcarrier indices spanning the second channel, and shifting the mapped LTF tones.

Aspect 7: The method of any of aspects 1-6, where the first bandwidth includes an 80 MHz bandwidth and the second bandwidth includes a 20 MHz bandwidth or a 40 MHz bandwidth.

Aspect 8: The method of any of aspects 1-7, where the RU allocation is based at least in part on a capability of the STA.

Aspect 9: A method for wireless communications by a STA, including: identifying an RU allocation for the STA and a first RU index, the first RU index associated with a first channel of a first bandwidth, and the RU allocation indicating a second channel of a second bandwidth; mapping a quantity of N tones to a first set of N subcarrier indices of a plurality of subcarrier indices spanning a frequency subblock of the first channel in accordance with a tone plan associated with the subblock, the subblock of a second bandwidth less than the first bandwidth and including a quantity of M tones that is greater than the quantity of N tones, and the first channel including more than one subblock, each subblock of the more than one subblock including a DC subcarrier and one or more guard tones at edges of the subblock; and transmitting a message over the first channel based on the mapping of the N tones in accordance with the tone plan.

Aspect 10: The method of aspect 9, where the tone plan associated with the subblock is different than a second tone plan associated with a second subblock of the first channel, the second subblock of a third bandwidth different from the first bandwidth and the second bandwidth.

Aspect 11: The method of aspect 10, where the first bandwidth includes an 80 MHz bandwidth, the second bandwidth includes a 20 MHz bandwidth, and the third bandwidth includes a 40 MHz bandwidth.

Aspect 12: The method of any of aspects 9-11, where the first channel includes four subblocks including the subblock, and each of the four subblocks is associated with the tone plan.

Aspect 13: The method of aspect 12, where the first bandwidth includes an 80 MHz bandwidth and the second bandwidth includes a 20 MHz bandwidth.

Aspect 14: The method of any of aspects 9-13, where the first channel includes two subblocks including the subblock, and each of the two subblocks is associated with the tone plan.

Aspect 15: The method of aspect 14, where the first bandwidth includes a 40 MHz bandwidth and the second bandwidth includes a 20 MHz bandwidth.

Aspect 16: The method of any of aspects 9-15, where the RU allocation is based at least in part on a capability of the STA.

Aspect 17: A method for wireless communications by an AP, including: transmitting a control message indicating an RU allocation for a STA including a first RU index, the first RU index associated with a first channel of a first bandwidth; and receiving a message over the first channel based at least in part on a quantity of N tones that are mapped to a first set of N non-contiguous subcarrier indices of a plurality of subcarrier indices spanning a second channel of a second bandwidth less than the first bandwidth and that are shifted to a second set of N subcarrier indices of the first channel according to a shifting value associated with the first RU index, and the second bandwidth, where the first set of N subcarrier indices are from a plurality of sets of N subcarrier indices of the second bandwidth and are associated with a second RU index that corresponds to a position of the first RU index mapped to the second bandwidth.

Aspect 18: The method of aspect 17, further including: receiving an STF over the first channel using one or more STF tones based at least in part on the mapping.

Aspect 19: The method of aspect 18, where a sequence and tone plan of the STF are associated with the second channel of the second bandwidth, and receiving the STF includes receiving the STF tones that are shifted to subcarrier indices of the first channel according to a shifting value associated with the first RU index and the second bandwidth.

Aspect 20: The method of any of aspects 18-19, where a sequence of the STF is associated with the first bandwidth, and receiving the STF is based at least in part on a plurality of STF tones that are mapped to one or more subcarrier indices distributed across the first channel and using the one or more STF tones that are within the second channel and that are of the plurality of STF tones.

Aspect 21: The method of any of aspects 18-20, where receiving the STF is in accordance with a CSD with a global CSD index associated with the second RU index.

Aspect 22: The method of any of aspects 17-21, further including: receiving an LTF over the first channel using one or more LTF tones based at least in part on the mapping of the N tones, where a sequence of the LTF is associated with the second bandwidth, and where receiving the LTF is based at least in part on one or more LTF tones that are mapped to one or more subcarrier indices of the plurality of subcarrier indices spanning the second channel and that are shifted.

Aspect 23: The method of any of aspects 17-22, where the first bandwidth includes an 80 MHz bandwidth and the second bandwidth includes a 20 MHz bandwidth or a 40 MHz bandwidth.

Aspect 24: The method of any of aspects 17-23, where the RU allocation is based at least in part on a capability of the STA.

Aspect 25: A method for wireless communications by an AP, including: transmitting a control message indicating an RU allocation for a STA and a first RU index, the first RU index associated with a first channel of a first bandwidth, and the RU allocation indicating a second channel of a second bandwidth; and receiving a message over the first channel based on a quantity of N tones that are mapped to a first set of N subcarrier indices of a plurality of subcarrier indices spanning a frequency subblock of the first channel in accordance with a tone plan associated with the subblock, the subblock of a second bandwidth less than the first bandwidth and including a quantity of M tones that is greater than the quantity of N tones, and the first channel including more than one subblock, each subblock of the more than one subblock including a DC subcarrier and one or more guard tones at edges of the subblock.

Aspect 26: The method of aspect 25, where the tone plan associated with the subblock is different than a second tone plan associated with a second subblock of the first channel, the second subblock of a third bandwidth different from the first bandwidth and the second bandwidth.

Aspect 27: The method of aspect 26, where the first bandwidth includes an 80 MHz bandwidth, the second bandwidth includes a 20 MHz bandwidth, and the third bandwidth includes a 40 MHz bandwidth.

Aspect 28: The method of any of aspects 25-27, where the first channel includes four subblocks including the subblock, and each of the four subblocks is associated with the tone plan.

Aspect 29: The method of aspect 28, where the first bandwidth includes an 80 MHz bandwidth and the second bandwidth includes a 20 MHz bandwidth.

Aspect 30: The method of any of aspects 25-29, where the first channel includes two subblocks including the subblock, and each of the two subblocks is associated with the tone plan.

Aspect 31: The method of aspect 30, where the first bandwidth includes a 40 MHz bandwidth and the second bandwidth includes a 20 MHz bandwidth.

Aspect 32: The method of any of aspects 25-31, where the RU allocation is based at least in part on a capability of the STA.

Aspect 33: A STA for wireless communications, including one or more memories storing processor-executable code, and one or more processors coupled with the one or more memories and individually or collectively operable to execute the code to cause the STA to perform a method of any of aspects 1-8.

Aspect 34: A STA for wireless communications, including at least one means for performing a method of any of aspects 1-8.

Aspect 35: A non-transitory computer-readable medium storing code for wireless communications, the code including instructions executable by one or more processors to perform a method of any of aspects 1-8.

Aspect 36: A STA for wireless communications, including one or more memories storing processor-executable code, and one or more processors coupled with the one or more memories and individually or collectively operable to execute the code to cause the STA to perform a method of any of aspects 9-16.

Aspect 37: A STA for wireless communications, including at least one means for performing a method of any of aspects 9-16.

Aspect 38: A non-transitory computer-readable medium storing code for wireless communications, the code including instructions executable by one or more processors to perform a method of any of aspects 9-16.

Aspect 39: An AP for wireless communications, including one or more memories storing processor-executable code, and one or more processors coupled with the one or more memories and individually or collectively operable to execute the code to cause the AP to perform a method of any of aspects 17-24.

Aspect 40: An AP for wireless communications, including at least one means for performing a method of any of aspects 17-24.

Aspect 41: A non-transitory computer-readable medium storing code for wireless communications, the code including instructions executable by one or more processors to perform a method of any of aspects 17-24.

Aspect 42: An AP for wireless communications, including one or more memories storing processor-executable code, and one or more processors coupled with the one or more memories and individually or collectively operable to execute the code to cause the AP to perform a method of any of aspects 25-32.

Aspect 43: An AP for wireless communications, including at least one means for performing a method of any of aspects 25-32.

Aspect 44: A non-transitory computer-readable medium storing code for wireless communications, the code including instructions executable by one or more processors to perform a method of any of aspects 25-32.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A station (STA), comprising:
a processing system that includes processor circuitry and memory circuitry that stores code, the processing system configured to cause the STA to:
identify a resource unit (RU) allocation for the STA comprising a first RU index, the first RU index associated with a first channel of a first bandwidth;
map a quantity of N tones to a first set of N non-contiguous subcarrier indices of a plurality of subcarrier indices spanning a second channel of a second bandwidth less than the first bandwidth, wherein the first set of N subcarrier indices are selected from a plurality of sets of N subcarrier indices of the second bandwidth based at least in part on a second RU index that corresponds to a position of the first RU index mapped to the second bandwidth;
shift the mapped N tones to a second set of N subcarrier indices of the first channel according to a shifting value associated with the first RU index, and the second bandwidth; and
transmit a message over the first channel based on the mapping of the N tones and the shifting.

2. The STA of claim 1, wherein the processing system is further configured to cause the STA to:
transmit a short training field (STF) over the first channel using one or more STF tones based at least in part on the mapping.

3. The STA of claim 2, wherein:
a sequence and tone plan of the STF are based at least in part on the second channel of the second bandwidth, and
transmitting the STF is based on shifting the STF tones to subcarrier indices of the first channel according to a shifting value associated with the first RU index and the second bandwidth.

4. The STA of claim 2, wherein:
a sequence of the STF is based at least in part on the first bandwidth, and
transmitting the STF is based at least in part on mapping a plurality of STF tones to one or more subcarrier indices distributed across the first channel and using the one or more STF tones that are within the second channel and that are of the plurality of STF tones.

5. The STA of claim 2, wherein transmitting the STF is in accordance with a cyclic shift delay (CSD) with a global CSD index associated with the second RU index.

6. The STA of claim 1, wherein the processing system is further configured to cause the STA to:
transmit a long training field (LTF) over the first channel using one or more LTF tones based at least in part on the mapping, wherein a sequence of the LTF is based at least in part on the second bandwidth, and wherein transmitting the LTF is based at least in part on mapping the one or more LTF tones to one or more subcarrier indices of the plurality of subcarrier indices spanning the second channel, and shifting the mapped LTF tones.

7. The STA of claim 1, wherein the first bandwidth comprises an 80 MHz bandwidth and the second bandwidth comprises a 20 MHz bandwidth or a 40 MHz bandwidth.

8. The STA of claim 1, wherein the RU allocation is based at least in part on a capability of the STA.

9. A station (STA), comprising:
a processing system that includes processor circuitry and memory circuitry that stores code, the processing system configured to cause the STA to:
identify a resource unit (RU) allocation for the STA and a first RU index, the first RU index associated with a first channel of a first bandwidth, and the RU allocation indicating a second channel of a second bandwidth;
map a quantity of N tones to a first set of N subcarrier indices of a plurality of subcarrier indices spanning a frequency subblock of the first channel in accordance with a tone plan associated with the subblock, the subblock of a second bandwidth less than the first bandwidth and comprising a quantity of M tones that is greater than the quantity of N tones, and the first channel comprising more than one subblock, each subblock of the more than one subblock comprising a direct current (DC) subcarrier and one or more guard tones at edges of the subblock; and
transmit a message over the first channel based on the mapping of the N tones in accordance with the tone plan.

10. The STA of claim 9, wherein the tone plan associated with the subblock is different than a second tone plan associated with a second subblock of the first channel, the second subblock of a third bandwidth different from the first bandwidth and the second bandwidth.

11. The STA of claim 10, wherein the first bandwidth comprises an 80 MHz bandwidth, the second bandwidth comprises a 20 MHz bandwidth, and the third bandwidth comprises a 40 MHz bandwidth.

12. The STA of claim 9, wherein:
the first channel comprises four subblocks including the subblock, and
each of the four subblocks is associated with the tone plan.

13. The STA of claim 12, wherein the first bandwidth comprises an 80 MHz bandwidth and the second bandwidth comprises a 20 MHz bandwidth.

14. The STA of claim 9, wherein:
the first channel comprises two subblocks including the subblock, and
each of the two subblocks is associated with the tone plan.

15. The STA of claim 14, wherein the first bandwidth comprises a 40 MHz bandwidth and the second bandwidth comprises a 20 MHz bandwidth.

16. The STA of claim 9, wherein the RU allocation is based at least in part on a capability of the STA.

17. An access point (AP), comprising:
a processing system that includes processor circuitry and memory circuitry that stores code, the processing system configured to cause the AP to:
transmit a control message indicating a resource unit (RU) allocation for a station (STA) comprising a first RU index, the first RU index associated with a first channel of a first bandwidth; and
receive a message over the first channel based at least in part on a quantity of N tones that are mapped to a first set of N non-contiguous subcarrier indices of a plurality of subcarrier indices spanning a second channel of a second bandwidth less than the first bandwidth and that are shifted to a second set of N subcarrier indices of the first channel according to a shifting value associated with the first RU index, and the second bandwidth, wherein the first set of N subcarrier indices are from a plurality of sets of N subcarrier indices of the second bandwidth and are associated with a second RU index that corresponds to a position of the first RU index mapped to the second bandwidth.

18. The AP of claim 17, wherein the processing system is further configured to cause the AP to:
receive a short training field (STF) over the first channel using one or more STF tones based at least in part on the mapping.

19. The AP of claim 18, wherein:
a sequence and tone plan of the STF are associated with the second channel of the second bandwidth, and
receiving the STF comprises receiving the STF tones that are shifted to subcarrier indices of the first channel according to a shifting value associated with the first RU index and the second bandwidth.

20. The AP of claim 18, wherein:
a sequence of the STF is associated with the first bandwidth, and
receiving the STF is based at least in part on a plurality of STF tones that are mapped to one or more subcarrier indices distributed across the first channel and using the one or more STF tones that are within the second channel and that are of the plurality of STF tones.

21. The AP of claim 18, wherein receiving the STF is in accordance with a cyclic shift delay (CSD) with a global CSD index associated with the second RU index.

22. The AP of claim 17, wherein the processing system is further configured to cause the AP to:
receive a long training field (LTF) over the first channel using one or more LTF tones based at least in part on the mapping of the N tones, wherein a sequence of the LTF is associated with the second bandwidth, and wherein receiving the LTF is based at least in part on one or more LTF tones that are mapped to one or more subcarrier indices of the plurality of subcarrier indices spanning the second channel and that are shifted.

23. The AP of claim 17, wherein the first bandwidth comprises an 80 MHz bandwidth and the second bandwidth comprises a 20 MHz bandwidth or a 40 MHz bandwidth.

24. An access point (AP), comprising:
a processing system that includes processor circuitry and memory circuitry that stores code, the processing system configured to cause the AP to:
transmit a control message indicating a resource unit (RU) allocation for a station (STA) and a first RU index, the first RU index associated with a first channel of a first bandwidth, and the RU allocation indicating a second channel of a second bandwidth; and
receive a message over the first channel based on a quantity of N tones that are mapped to a first set of N subcarrier indices of a plurality of subcarrier indices spanning a frequency subblock of the first channel in accordance with a tone plan associated with the subblock, the subblock of a second bandwidth less than the first bandwidth and comprising a quantity of M tones that is greater than the quantity of N tones, and the first channel comprising more than one subblock, each subblock of the more than one subblock comprising a direct current (DC) subcarrier and one or more guard tones at edges of the subblock.

25. The AP of claim 24, wherein the tone plan associated with the subblock is different than a second tone plan associated with a second subblock of the first channel, the second subblock of a third bandwidth different from the first bandwidth and the second bandwidth.

26. The AP of claim 25, wherein the first bandwidth comprises an 80 MHz bandwidth, the second bandwidth comprises a 20 MHz bandwidth, and the third bandwidth comprises a 40 MHz bandwidth.

27. The AP of claim 24, wherein:
the first channel comprises four subblocks including the subblock, and
each of the four subblocks is associated with the tone plan.

28. The AP of claim 27, wherein the first bandwidth comprises an 80 MHz bandwidth and the second bandwidth comprises a 20 MHz bandwidth.

29. The AP of claim 24, wherein:
the first channel comprises two subblocks including the subblock, and
each of the two subblocks is associated with the tone plan.

30. The AP of claim 29, wherein the first bandwidth comprises a 40 MHz bandwidth and the second bandwidth comprises a 20 MHz bandwidth.
